(19) United States
(12) Patent Application Publication
(10) Pub. No.: US 2026/0128367 A1
(43) Pub. Date: May 7, 2026

(54) ALL SOLID-STATE BATTERY

(71) Applicant: QUANTUMSCAPE BATTERY, INC., San Jose, CA (US)

(72) Inventors: Cheng-Chieh CHAO, San Jose, CA (US); Yuki KATOH, San Jose, CA (US); Ran TAO, San Jose, CA (US); Yaosen TIAN, San Jose, CA (US); Saori TOKUOKA, San Jose, CA (US); Hyeseung CHUNG, San Jose, CA (US); Yang LI, San Jose, CA (US); Dennis LU, San Jose, CA (US); Yuhao WANG, San Jose, CA (US); Jing XU, San Jose, CA (US)

(21) Appl. No.: 19/427,448

(22) Filed: Dec. 19, 2025

Related U.S. Application Data
(63) Continuation of application No. PCT/US2025/037613, filed on Jul. 14, 2025.
(60) Provisional application No. 63/671,443, filed on Jul. 15, 2024.

(51) Int. Cl. H01M 10/0562; H01M 4/02; H01M 4/131; H01M 4/134; H01M 4/38; H01M 4/525; H01M 4/62; H01M 50/431; H01M 50/449

(52) U.S. Cl. CPC H01M 10/0562; H01M 4/131; H01M 4/134; H01M 4/382; H01M 4/525; H01M 4/623; H01M 50/431; H01M 50/449; H01M 2004/021; H01M 2004/027; H01M 2004/028; H01M 2300/0077; H01M 2300/008

(57) ABSTRACT

The present disclosure sets forth an all solid-state battery that includes a positive electrode having cathode active material, binder, and catholyte material; a solid-state buffer on at least one side of the positive electrode layer; a bonding layer, and a lithium-stuffed garnet electrolyte separator.

### CROSS REFERENCE TO RELATED APPLICATIONS

This application is a Continuation of International Patent Application No. PCT/US2025/037613, filed Jul. 14, 2025, which claims priority to, and the benefit of, U.S. Provisional Patent Application No. 63/671,443, filed Jul. 15, 2024, the entire contents of each of which are herein incorporated by reference in its entirety for all purposes.

### FIELD

The present disclosure concerns solid-state rechargeable batteries, which are also known as secondary batteries.

### BACKGROUND

Solid-state batteries operate within comparatively wider temperature, voltage, and pressure ranges than liquid electrolyte-based batteries do. Solid-state batteries may also include solid-state positive and negative electrodes. Solid-state batteries may include, for example, a metallic lithium (Li) negative electrode. Li metal negative electrodes maximize the energy density in a Li⁺ ion battery because they maximize the positive and negative electrode voltage differential. Solid-state rechargeable batteries are predicted to be safer (e.g., less flammable) and have higher energy and power densities than liquid electrolyte-based batteries currently commercially available. However, a series of unmet challenges remain, which has prevented the realization of commercially viable solid-state batteries.

Because a series of unmet challenges remain, solutions to the aforementioned problems as well as others in the relevant filed are needed. The instant disclosure provides compositions, processes, and methods for overcoming these and other challenges and problems.

### SUMMARY

In an aspect, set forth herein is an electrochemical cell comprising: a positive electrode current collector; a positive electrode comprising a catholyte; a solid-state buffer layer in contact with the positive electrode and opposite the current collector; a separator comprising a lithium-stuffed garnet layer and a metal layer; wherein the thickness of the buffer layer is greater than 0% and less than 50% the thickness of the positive electrode.

In an aspect, set forth herein is an electrochemical cell comprising: a positive electrode current collector; a positive electrode comprising a catholyte; a solid-state buffer layer in contact with the positive electrode and opposite the current collector; a separator comprising a lithium-stuffed garnet layer and a metal layer; wherein the thickness of the buffer layer is 0.5 μm to 50 μm.

In an aspect, set forth herein is a solid-state battery comprising: a positive electrode comprising cathode active material, at least one binder, and a catholyte; a solid-state buffer layer disposed on the positive electrode; a bonding layer disposed on the solid-state buffer layer; and a separator disposed on the bonding layer, wherein the separator comprises a lithium-stuffed garnet layer and a metal layer; and wherein the solid-state buffer layer comprises a different material than the catholyte material. In some embodiments, the lithium-stuffed garnet layer of the separator comprises a lithium-stuffed garnet selected from LiₓLa_{y}ZrₓOₜ·qAl₂O₃, wherein 4<x<10, 1<y<4, 1<z<3, 6<t<14, and 0≤q≤1; or wherein the lithium-stuffed garnet layer of the separator comprises a lithium-stuffed garnet characterized by the formula LiₐLa_{b}Zr_{c}Al_{d}Me″ₑO_{f}, wherein 5<a<8.5; 2<b<4; 0≤c≤2.5; 0≤d<2; 0≤e<2, and 10<f<13 and Me″ is a metal selected from the group consisting of Nb, Ga, Ta, and combinations thereof.

### BRIEF DESCRIPTIONS OF THE DRAWINGS

FIG. 1A shows a schematic illustration of an example electrochemical cell.

FIG. 1B is an SEM image of an example of the electrochemical cell disclosed herein.

FIG. 2 is a plot of voltage as a function of active cycle charge density (mAh/cm²) over 50 cycles, as described in the examples.

FIG. 3 is a plot of discharge ASR after 4 weeks of storage.

FIG. 4 is a focused ion-beam cross-sectional scanning electron microscopy image of a solid-state cathode made using the casting process described in the examples.

FIG. 5 is a focused ion-beam cross-sectional scanning electron microscopy image of a solid-state cathode made using the solvent-free process according to the examples.

FIG. 6 is a schematic illustration of an embodiment of the electrochemical cell described herein.

FIG. 7 is a plot of discharge capacity as a function of cycle number for up to 2000 cycles at 1C-1C (charge-discharge) rates and 30° C.

FIG. 8A is a plot of state of charge as a function of cycle time at 4C charge rate and 45° C. FIG. 8B is a plot of discharge capacity as a function of cycle number for up to 300 cycles at 4C-0.5C (charge-discharge) rates and 45° C.

FIG. 9 is a plot of discharge ASR after 4 weeks of storage.

### DETAILED DESCRIPTION

### Definitions

If a definition provided in any material incorporated by reference herein conflicts with a definition provided herein, the definition provided herein controls.

As used herein, the term “about” when qualifying a number, e.g., about 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, the phrase “active material,” refers to a material that intercalates, or converts with, lithium in a reversible reaction such that the active material is suitable for use in a rechargeable battery. Active materials may include intercalation materials such as NCA or NMC. Active materials may include conversion chemistry materials such as FeF₃. For example, active materials may include, but are not limited to, any active material set forth in US20160211517A1, which published Jul. 21, 2016, and is titled LITHIUM RICH NICKEL MANGANESE COBALT OXIDE.

As used herein the phrase “applying a pressure,” refers to a process whereby an external device, e.g., a calender, induces a pressure in another material.

As used herein, the phrase “at least one member selected from the group,” includes a single member from the group, more than one member from the group, or a combination of members from the group. At least one member selected from the group consisting of A, B, and C includes, for example, A, only, B, only, or C, only, as well as A and B as well as A and C as well as B and C as well as A, B, and C or any other all combinations of A, B, and C.

As used herein “ASR” refers to area-specific resistance. ASR is measured using electrochemical impedance spectroscopy (EIS). EIS can be performed on a Biologic VMP3 instrument or an equivalent thereof. In an ASR measurement, lithium contacts are deposited on two sides of a sample. An AC voltage of 25 mV rms is applied across a frequency of 300 kHz-0.1 mHz while the current is measured. EIS partitions the ASR into the bulk contribution and the interfacial ASR contribution, by resolving two semicircles in a Nyquist plot.

As used herein, the phrase “lithium interfacial resistance,” refers to the interfacial resistance of a material towards the incorporation of Li⁺ ions. A lithium interfacial ASR (ASR_{interface}) is calculated from the interfacial resistance (R_{interface}), by the equation ASR_{interface}=R_{interface}*A/2, where A is the area of the electrodes in contact with the separator and the factor of 2 accounts for 2 interfaces when measured in a symmetric cell and R_{interface}=Rₜₒₜₐₗ−R_{bulk}, wherein Rₜₒₜₐₗ is total resistance and R_{bulk} is bulk resistance.

As used herein the phrase “bonding layer” refers to a layer which adheres a separator layer to an electrolyte layer or buffer layer. For example, the bonding layer may include compositions set forth in WO 2018/075972, which published Apr. 26, 2018.

As used herein, “binder” refers to a polymer with the capability to increase the adhesion and/or cohesion of material, such as an electrode, the solids in a green tape, among others. Suitable binders may include, but are not limited to, PVDF, PVDF-HFP, SBR, and ethylene alpha-olefin copolymer. A “binder” refers to a material that assists in the adhesion of another material. For example, as used herein, polyvinyl butyral is a binder because it is useful for adhering garnet materials. Other binders may include polycarbonates. Other binders may include poly acrylates and poly methacrylates. These examples of binders are not limiting as to the entire scope of binders contemplated here but merely serve as examples. Binders useful in the present disclosure include, but are not limited to, polypropylene (PP), polyethylene, atactic polypropylene (aPP), isotactic polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), polyethylene-co-poly (methylene cyclopentane) (PE-co-PMCP), poly(methyl methacrylate) (and other acrylics), acrylic, polyvinylacetacetal resin, polyvinyl butyral resin, PVB, polyvinyl acetal resin, stereoblock polypropylenes, polypropylene polymethylpentene copolymer, polyethylene oxide (PEO), PEO block copolymers, silicone, and the like. In some embodiments, including any of the foregoing, the binder is a polymer is selected from the group consisting of polyacrylonitrile (PAN), polypropylene, polyethylene, polyethylene oxide (PEO), poly methyl methacrylate (PMMA), polyvinyl chloride (PVC), polyvinyl pyrrolidone (PVP), polyethylene oxide poly(allyl glycidyl ether) PEO-AGE, polyethylene oxide 2-methoxy ethoxy ethyl glycidyl ether (PEO-MEEGE), polyethylene oxide 2-methoxyethoxyethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), ethylene propylene (EPR), nitrile rubber (NPR), styrene-butadiene-rubber (SBR), polybutadiene polymer, polybutadiene rubber (PB), polyisobutadiene rubber (PIB), polyolefin, alpha-polyolefin, ethylene alpha-polyolefin, polyisoprene rubber (PI), polychloroprene rubber (CR), acrylonitrile-butadiene rubber (NBR), and polyethyl acrylate (PEA).

As used herein, the term “buffer” refers to a single ion conducting, solid-state electrolyte that is finely mixed within or combined with the positive electrode components or is a layer which is in direct contact with the positive electrode, e.g., an electrolyte layer laminated to the positive electrode layer. Single ion conducting means that the material only conducts one type of ion, e.g., a Li⁺ ion with a transference number of greater than 0.9. Solid-state means that the buffer exists in the solid phase at ambient temperatures and pressures.

As used herein, the phrase “buffer is mixed within the positive electrode layer,” means that the buffer material is ground up, e.g., milled, and then mixed with the other positive electrode layer compounds, e.g., active material and conductive carbon, when the positive electrode layer is formed.

As used herein the phrase “casting a film,” refers to the process of delivering or transferring a liquid or a slurry into a mold, or onto a substrate, such that the liquid or the slurry forms, or is formed into, a film. Casting may be done via doctor blade, meyer rod, comma coater, gravure coater, microgravure, reverse comma coater, slot die, slip and/or tape casting, and other methods.

As used herein, the phrase “characterized by the formula” refers to a description of a chemical compound by its chemical formula.

As used herein, the phrase “current collector” refers to a component or layer in a secondary battery through which electrons conduct, to or from an electrode in order to complete an external circuit, and which are in direct contact with the electrode to or from which the electrons conduct. In some embodiments, the current collector is a metal (e.g., Al, Cu, or Ni, steel, alloys thereof, or combinations thereof) layer which is laminated to a positive or negative electrode. In some embodiments, the current collector is Al. In some embodiments, the current collector is Cu. In some embodiments, the current collector is Ni. In some embodiments, the current collector is steel. In some embodiments, the current collector is an alloy of Al. In some embodiments, the current collector is an alloy of Cu. In some embodiments, the current collector is an alloy of steel. In some embodiments, the current collector is Al. In some embodiments, the current collector is coated with carbon. In some embodiments, the current collector comprises a combination of the above metals. During charging and discharging, electrons move in the opposite direction to the flow of Li ions and pass through the current collector when entering or exiting an electrode. The current collector can be a carbon coated aluminum foil. In an example, the thickness of the aluminum is between, and including, 5 μm and 50 μm.

As used herein, the phrase “D₅₀ diameter” or “D₅₀ particle size” refers to the median size, in a distribution of sizes, measured by microscopy techniques or other particle size analysis techniques, such as, but not limited to, scanning electron microscopy, dynamic light scattering, or laser diffraction. D₅₀ describes a characteristic dimension of particles at which 50% of the particles are smaller than the recited size.

As used herein, the phrase “D₉₀ diameter” or “D₉₀ particle size” refers to the size, in a distribution of sizes, measured by microscopy techniques or other particle size analysis techniques, such as, but not limited to, scanning electron microscopy, dynamic light scattering or laser diffraction. D₉₀ describes a characteristic dimension of particles at which 90% of the particles are smaller than the recited size.

As used herein, the term “contact” means direct contact unless specified otherwise. For electrically conductive materials, contact means contact sufficient for electrical conduction to occur between the contacting materials. For ionically conductive materials, contact means contact sufficient for ionic conduction to occur between the contacting materials. Two materials which are in direct contact are positioned without an interleaving layer between the two materials. As used herein, the phrase “electrical contact,” refers to contact sufficient for electrical conduction to occur between the contacting materials.

As used herein, the phrase “direct contact,” means that two materials are in sufficient physical contact to conduct an electronic or ionic current therebetween, if the materials are electrically or ionically conductive. Direct contact between two materials, one of which is electrically or ionically insulating, means that the two materials share an interface that transmits an applied force or pressure.

As used herein, the phrase “electrical contact” means that two materials are in direct contact and can conduct an electrical current through the point(s) of direct contact.

As used herein, the terms “cathode” and “anode” refer to the electrodes of a battery. During a charge cycle in a Li-secondary battery, Li ions leave the cathode and move through an electrolyte and to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode. The cathode active material is not particularly limited herein, and a publicly known cathode active material utilized in all-solid-state batteries can be used. Specific examples of such a cathode active material include the following: manganese oxide (MnO), iron oxides, copper oxides, nickel oxides, lithium-manganese complex oxides (e.g., LiMn₂O₄ or LiMnO₂), lithium-nickel complex oxides (e.g., LiNiO₂), lithium-cobalt complex oxides (e.g. LiCoO₂), lithium cobalt nickel oxides (LiNi_{1-y}Co_{y}O₂), lithium-manganese-cobalt complex oxides (e.g., LiMn_{y}Co_{1-y}O₂), lithium-nickel-manganese-cobalt oxides (e.g. LiNiₓMn_{y}Co_{1-x-y}O₂), lithium-nickel-cobalt-aluminum oxides (e.g. LiNiₓAl_{y}Co_{1-x-y}O₂), spinel-phase lithium-manganese-nickel complex oxides (e.g., LiMn_{1.5}Ni_{0.5}O₄), lithium phosphates having an olivine structure (e.g., LiFePO₄, which is also known as LFP, and LiCoPO₄), lithium iron manganese phosphates (e.g., LiFeMnPO₄, also known as LMFP), lithium phosphates having a NASICON-type structure (e.g., Li₇V₂(PO₄)₃), iron (III) sulfate (Fe₂(SO₄)₃), and vanadium oxides (e.g., V₂O₅). One type thereof can be used alone, or two or more types thereof can be used in combination. Preferably, x and y in these chemical formulas lie within the ranges of 0<x<1, and 0<y<1.

As used herein, the phrase “double-sided solid-state cathode” refers to two solid-state cathode layers separated by one or two cathode current collectors disposed in between the two layers.

As used herein, the phrases “electrochemical cell” or “battery cell” shall, unless specified to the contrary, mean a single cell including a positive electrode and a negative electrode, which have ionic communication with each other by way of an electrolyte. In some embodiments, a battery or module may include multiple positive electrodes and/or multiple negative electrodes enclosed in one container or otherwise put together one on top of another, e.g., a stack of electrochemical cells. A stack of electrochemical cells or “electrochemical stack,” may be referred to as a multi-layered cell. A symmetric cell may be a cell having two Li metal anodes separated by a solid-state electrolyte.

As used herein, the phrase “electrochemical device” refers to an energy storage device, such as, but not limited to a Li-secondary battery that operates or produces electricity or an electrical current by an electrochemical reaction, e.g., a conversion chemistry reaction such as 3Li+FeF₃↔3LiF+Fe

As used herein, the term “electrolyte,” refers to a material that allows ions, e.g., Li⁺, to migrate therethrough, but which does not allow electrons to conduct therethrough. The ionic conductivity is greater than the electronic conductivity by a factor of at least 1000. Electrolytes are useful for electrically insulating the cathode and anode of a secondary battery while allowing ions, e.g., Li⁺, to transmit through the electrolyte. Solid electrolytes, In some embodiments, rely on ion hopping and/or diffusion through rigid structures. Solid electrolytes may be also referred to as fast ion conductors or super-ionic conductors. In this case, a solid electrolyte layer may be also referred to as a solid electrolyte separator or a solid-state electrolyte separator.

As used herein, the phrase “electrochemical device” refers to an energy storage device, such as, but not limited to a Li-secondary battery that operates or produces electricity or an electrical current by an electrochemical reaction, e.g., a conversion chemistry reaction such as 3Li+FeF₃↔3LiF+Fe.

As used herein, the phrase “film thickness” refers to the distance, or median measured distance, between the top and bottom faces of a film. As used herein, the term “thickness” when referring to a layer refers to the distance, or median measured distance, between the top and bottom faces of the layer. As used herein, the top and bottom faces refer to the sides of the film having the largest surface area. Scanning electron microscopy is used to measure thickness unless specified otherwise explicitly.

As used herein, the term “thin film” refers to a film having the components, compositions, or materials described herein where the film has an average thickness dimension of about 10 nm to about 100 μm. In some embodiments, thin refers to a film that is less than about 1 μm, 10 μm, or 50 μm in thickness.

As used herein, the phrase “lithium-stuffed garnet” refers to oxides that are characterized by a crystal structure related to a garnet crystal structure. Some examples of lithium-stuffed garnets are set forth in U.S. Patent Application Publication No. 2015/0099190, which published Apr. 9, 2015, and was filed Oct. 7, 2014 as Ser. No. 14/509,029, and is incorporated by reference herein in its entirety for all purposes. This application describes Li-stuffed garnet solid-state electrolytes used in solid-state lithium rechargeable batteries. These Li-stuffed garnets generally having a composition according to Li_{A}La_{B}M′_{C}M″_{D}Ze_{E}O_{F}, Li_{A}La_{B}M′_{C}M″_{D} Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<3, 10<F<13, and M′ and M″ are each, independently in each instance selected from Ga, Al, Mo, W, Nb, Sb, Ca, Ba, Sr, Ce, Hf, Rb, and Ta, or LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Ga, Nb, Ta, V, W, Mo, and Sb and as otherwise described in U.S. Patent Application Publication No. 2015/0099190. As used herein, lithium-stuffed garnets, and garnets, generally, include, but are not limited to, Li_{7.0±δ}La₃(Zrₜ₁+Nbₜ₂+Taₜ₃)O₁₂+0.35Al₂O₃; wherein δ is from 0 to 3 and (t1+t2+t3=2) so that the La:(Zr/Nb/Ta) ratio is 3:2. For example, δ is 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0. In some embodiments, the Li-stuffed garnet herein has a composition of Li_{7±δ}Li₃Zr₂O₁₂·xAl₂O₃. In yet another embodiment, the Li-stuffed garnet herein has a composition of Li_{7±δ}Li₃Zr₂O₁₂·0.22Al₂O₃. In yet other examples, the Li-stuffed garnet herein has a composition of Li_{7±δ}Li₃Zr₂O₁₂·0.35Al₂O₃. In certain other examples, the Li-stuffed garnet herein has a composition of Li_{7±δ}Li₃Zr₂O₁₂·0.5Al₂O₃. In another example, the Li-stuffed garnet herein has a composition of Li_{7±δ}Li₃Zr₂O₁₂·0.75Al₂O₃. Also, L-stuffed garnets used herein include, but are not limited to, LiₓLa₃Zr₂O_{F}+yAl₂O₃, wherein x ranges from 5.5 to 9; and y ranges from 0.05 to 1. In these examples, subscripts x, y, and F are selected so that the Li-stuffed garnet is charge neutral. In some embodiments x is 7 and y is 1.0. In some embodiments, x is 5 and y is 1.0. In some embodiments, x is 6 and y is 1.0. In some embodiments, x is 8 and y is 1.0. In some embodiments, x is 9 and y is 1.0. In some embodiments x is 7 and y is 0.35. In some embodiments, x is 5 and y is 0.35. In some embodiments, x is 6 and y is 0.35. In some embodiments, x is 8 and y is 0.35. In some embodiments, x is 9 and y is 0.35. In some embodiments x is 7 and y is 0.7. In some embodiments, x is 5 and y is 0.7. In some embodiments, x is 6 and y is 0.7. In some embodiments, x is 8 and y is 0.7. In some embodiments, x is 9 and y is 0.7. In some embodiments x is 7 and y is 0.75. In some embodiments, x is 5 and y is 0.75. In some embodiments, x is 6 and y is 0.75. In some embodiments, x is 8 and y is 0.75. In some embodiments, x is 9 and y is 0.75. In some embodiments x is 7 and y is 0.8. In some embodiments, x is 5 and y is 0.8. In some embodiments, x is 6 and y is 0.8. In some embodiments, x is 8 and y is 0.8. In some embodiments, x is 9 and y is 0.8. In some embodiments x is 7 and y is 0.5. In some embodiments, x is 5 and y is 0.5. In some embodiments, x is 6 and y is 0.5. In some embodiments, x is 8 and y is 0.5. In some embodiments, x is 9 and y is 0.5. In some embodiments x is 7 and y is 0.4. In some embodiments, x is 5 and y is 0.4. In some embodiments, x is 6 and y is 0.4. In some embodiments, x is 8 and y is 0.4. In some embodiments, x is 9 and y is 0.4. In some embodiments x is 7 and y is 0.3. In some embodiments, x is 5 and y is 0.3. In some embodiments, x is 6 and y is 0.3. In some embodiments, x is 8 and y is 0.3. In some embodiments, x is 9 and y is 0.3. In some embodiments x is 7 and y is 0.22. In some embodiments, x is 5 and y is 0.22. In some embodiments, x is 6 and y is 0.22. In some embodiments, x is 8 and y is 0.22. In some embodiments, x is 9 and y is 0.22. Also, Li-stuffed garnets as used herein include, but are not limited to, LiₓLa₃Zr₂O₁₂+yAl₂O₃, wherein y is from 0 to 1 and includes 0 and 1. In one embodiment, the Li-stuffed garnet herein has a composition of Li₇Li₃Zr₂O₁₂.

As used herein, garnet or Li-stuffed garnet does not include YAG-garnets (i.e., yttrium aluminum garnets or, e.g., Y₃Al₅O₁₂). As used herein, garnet does not include silicate-based garnets such as pyrope, almandine, spessartine grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrases “garnet precursor chemicals,” “chemical precursor to a garnet-type electrolyte,” “precursors to garnet” and “garnet precursor materials” refer to chemicals which react to form a lithium-stuffed garnet material described herein. These chemical precursors include, but are not limited to lithium hydroxide (e.g., LiOH), lithium oxide (e.g. ₂O), lithium carbonate (e.g., LiCO₃), zirconium oxide (e.g., ZrO₂), lanthanum oxide (e.g., La₂O₃), lanthanum hydroxide (e.g., La(OH)₃), aluminum oxide (e.g., Al₂O₃), aluminum hydroxide (e.g., Al(OH)₃), AlOOH, aluminum (e.g., Al), Boehmite, gibbsite, corundum, aluminum nitrate (e.g., Al(NO₃)₃), aluminum nitrate nonahydrate, niobium oxide (e.g., Nb₂O₅), gallium oxide (Ga₂O₃), and tantalum oxide (e.g., Ta₂O₅). Other precursors to garnet materials may be suitable for use with the methods set forth herein.

As used herein the phrase “garnet-type electrolyte,” refers to an electrolyte that includes a lithium-stuffed garnet material described herein as a Li⁺ ion conductor. The advantages of Li-stuffed garnet solid-state electrolytes are many, including as a substitution for liquid, flammable electrolytes commonly used in lithium rechargeable batteries.

As used herein, the term “LXPS” or “LPS+X” refers to a lithium conducting electrolyte comprising Li, P, S, and X, where X═Cl, Br, and/or I. For example, “LSPI” refers to a lithium conducting electrolyte comprising Li, P, S, and I. More generally, it is understood to include aLi₂S+bP₂S_{y}+cLiX where X═Cl, Br, and/or I and where y=3-5 and where a/b=2.5-4.5 and where (a+b)/c=0.5-15.

As used herein, the term “LBHPS” refers to a lithium conducting electrolyte having, Li, B, H, P, and S, for example, A(LiBH₄)(1-A)(P₂S₅) wherein 0.05≤A≤0.95.

As used herein, “LSS” refers to lithium silicon sulfide which can be described as Li₂S—SiS₂, Li—SiS₂, Li—S—Si, and/or a catholyte consisting essentially of Li, S, and Si. LSS refers to an electrolyte material characterized by the formula LiₓSi_{y}S_{z} where 0.33≤x≤0.5, 0.1≤y≤0.2, 0.4≤z≤0.55, and it may include up to 10 atomic % oxygen. LSS also refers to an electrolyte material comprising Li, Si, and S. In some embodiments, LSS is a mixture of Li₂S and SiS₂. In some embodiments, the molar ratio of Li₂S:SiS₂ is 90:10, 85:15, 80:20, 75:25, 70:30, 2:1, 65:35, 60:40, 55:45, or 50:50. LSS may be doped with compounds such as LiₓPO_{y}, LiₓBO_{y}, Li₄SiO₄, Li₃MO₄, Li₃MO₃, PSₓ, and/or lithium halides such as, but not limited to, LiI, LiCl, LiF, or LiBr, wherein 0<x≤5 and 0<y≤5.

As used herein, the term “LSTPS” refers to an electrolyte material having Li, Si, P, Sn, and S chemical constituents.

As used herein, “LSPSO,” refers to LSPS that is doped with, or has, O present. In some embodiments, “LSPSO,” is a LSPS material with an oxygen content between 0.01 and 10 atomic %.

As used herein, “LATP,” refers to an electrolyte material having Li, As, Sn, and P chemical constituents.

As used herein “LAGP,” refers to an electrolyte material having Li, As, Ge, and P chemical constituents.

As used herein, “LXPSO” refers to a catholyte material characterized by the formula LiₐMP_{b}S_{c}O_{d}, where M is Si, Ge, Sn, and/or Al, and where 2≤a≤8, 0.5≤b≤2.5, 4≤c≤12, and d<3. LXPSO refers to LXPS, as defined above, and having oxygen doping at from 0.1 to about 10 atomic %. LPSO refers to LPS, as defined above, and having oxygen doping at from 0.1 to about 10 atomic %.₁₃ (50:50 Li₂S:SiS₂) with 0.1-10 mol. % Li₃PO₄. In some embodiments, “SLOPS” includes Li₂₆Si₇S₂₇ (65:35 Li₂S:SiS₂) with 0.1-10 mol. % Li₃PO₄. In some embodiments, “SLOPS” includes Li₄SiS₄ (67:33 Li₂S:SiS₂) with 0.1-5 mol. % Li₃PO₄. In some embodiments, “SLOPS” includes Li₁₄Si₃S₁₃ (70:30 Li₂S:SiS₂) with 0.1-5 mol. % Li₃PO₄. In some embodiments, “SLOPS” is characterized by the formula (1−x)(60:40 Li₂S:SiS₂)*(x) (Li₃PO₄), wherein x is from 0.01 to 0.99. As used herein, “LBS-POX” refers to an electrolyte composition of Li₂S:B₂S₃:Li₃PO₄:LiX where X is a halogen (X═F, Cl, Br, I). The composition can include Li₃BS₃ or Li₅B₇S₁₃ doped with 0-30% lithium halide such as LiI and/or 0-10% Li₃PO₄.

As used herein, the term “LPSCl” refers to an electrolyte material having Li, P, S, and Cl chemical constituents. As used herein, the term “LPSBr” refers to an electrolyte material having Li, P, S, and Br chemical constituents. As used herein, the term “LPSI” refers to an electrolyte material having Li, P, S, and I chemical constituents. LXPSO refers to LXPS, as defined above, and having oxygen doping at from 0.1 to about 10 atomic %. LPSO refers to LPS, as defined above, and having oxygen doping at from 0.1 to about 10 atomic %.

As used herein, the term “LAPS” refers to an electrolyte material having Li, As, P, and S, chemical constituents. “LPSCl” refers to an electrolyte material having Li, P, S, and Cl chemical constituents. As used herein, the term “LTPS” refers to an electrolyte material having Li, P, Sn, and S, chemical constituents. As used herein, the term “LSPS” refers to an electrolyte material having Li, P, Si, and S, chemical constituents. As used herein, the term “LGPS” refers to an electrolyte material having Li, P, Ge, and S, chemical constituents. As used herein, the term “LPS” refers to an electrolyte material having Li, P, and S, chemical constituents. As used herein, the term “LSTPSCl” refers to an electrolyte material having Li, Si, P, Sn, S, and Cl chemical constituents. As used herein, the term “LSPSCl” refers to an electrolyte material having Li, Si, P, S, and Cl chemical constituents. As used herein, the term “LSPSBr” refers to an electrolyte material having Li, Si, P, S, and Br chemical constituents. As used herein, “LTS” refers to a lithium tin sulfide compound which can be described as Li₂S:SnS₂:As₂S₅, Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤z≤0.65. In some embodiments, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In and/or lithium halides such as, but not limited to, LiI, LiCl, LiF, or LiBr.

As used herein, the term “LATS” refers to an LTS further including Arsenic (As):As₂S₅, Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤z≤0.65. In some embodiments, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In and/or lithium halides such as, but not limited to, LiI, LiCl, LiF, or LiBr.

As used herein, the term “LBHI” or “LiBHI” refers to a lithium conducting electrolyte having Li, B, H, and I. More generally, it is understood to include aLiBH₄+bLIX where X═Cl, Br, and/or I and where a:b=7:1, 6:1, 5:1, 4:1, 3:1, 2:1, or within the range a/b=2-4. LBHI may further include nitrogen in the form of aLiBH₄+bLiX+cLiNH₂ where (a+c)/b=2-4 and c/a=0-10.

As used herein, the term “LBHXN” refers to a composition characterized as A·(LiBH₄)·B·(LiX)·C·(LiNH₂) wherein X is fluorine (F), bromine (Br), chloride (Cl), iodine (I), or a combination thereof, and wherein 3≤A≤6, 2≤B≤5, and 0≤C≤9. As used herein, the term “LBHFN” refers to a composition characterized as A·(LiBH₄)·B·(LiF)·C·(LiNH₂) and wherein 3≤A≤6, 2≤B≤5, and 0≤C≤9. As used herein, the term “LBHBrN” refers to a composition characterized as A·(LiBH₄)·B·(LiBr)·C·(LiNH₂) and wherein 3≤A≤6, 2≤B≤5, and 0≤C≤9. As used herein, the term “LBHClN” refers to a composition characterized as A·(LiBH₄)·B·(LiCl)·C·(LiNH₂) and wherein 3≤A≤6, 2≤B≤5, and 0≤C≤9. As used herein, the term “LBHIN” refers to a composition characterized as A·(LiBH₄)·B·(LiI)·C·(LiNH₂) and wherein 3≤A≤6, 2≤B≤5, and 0≤C≤9.

As used herein, “SLOBS” includes, unless otherwise specified, a 60:40 molar ratio of Li₂S:SiS₂ with 0.1-10 mol. % LiBH₄. In some embodiments, “SLOBS” includes Li₁₀Si₄S₁₃ (50:50 Li₂S:SiS₂) with 0.1-10 mol. % LiBH₄. In some embodiments, “SLOBS” includes Li₂₆Si₇S₂₇ (65:35 Li₂S:SiS₂) with 0.1-10 mol. % LiBH₄. In some embodiments, “SLOBS” includes Li₄SiS₄ (67:33 Li₂S:SiS₂) with 0.1-5 mol. % LiBH₄. In some embodiments, “SLOBS” includes Li₁₄Si₃S₁₃ (70:30 Li₂S:SiS₂) with 0.1-5 mol. % LiBH₄. In some embodiments, “SLOBS” is characterized by the formula (1−x)(60:40 Li₂S:SiS₂)*(x)(Li₃BO₄), wherein x is from 0.01 to 0.99. As used herein, “LBS-BOX” refers to an electrolyte composition of Li₂S:B₂S₃:LiBH₄:LiX where X is a halogen (X═F, Cl, Br, I). The composition can include Li₃BS₃ or Li₅B₇S₁₃ doped with 0-30% lithium halide such as LiI and/or 0-10% Li₃PO₄.

As used herein, the phrase “made of the same type of material,” refers to two or more different physical forms of a material but which includes same chemical composition. For example, lithium-stuffed garnet powder and a lithium-stuffed garnet thin film are made of the same type of material. For example, LSTPS powder and an LSTPS thin film are made of the same type of material. For example, LSTPS powder and another form of LSTPS powder are made of the same type of material.

As used herein the term “making,” refers to the process or method of forming or causing to form the object that is made. For example, making an energy storage electrode includes the process, process steps, or method of causing the electrode of an energy storage device to be formed. The end result of the steps constituting the making of the energy storage electrode is the production of a material that is functional as an electrode

As used here, the phrase “positive electrode,” refers to the electrode in a secondary battery towards which positive ions, e.g., Li⁺, conduct, flow, or move during discharge of the battery. As used herein, the phrase “negative electrode” refers to the electrode in a secondary battery from where positive ions, e.g., Li⁺, flow, or move during discharge of the battery. In a battery comprised of a Li-metal electrode and a conversion chemistry, intercalation chemistry, or combination conversion/intercalation chemistry-including electrode (i.e., cathode active material; e.g., NiFₓ, NCA, LiNiₓMn_{y}Co_{z}O₂ [NMC] or LiNiₓAl_{y}Co_{z}O₂ [NCA], wherein x+y+z=1), the electrode having the conversion chemistry, intercalation chemistry, or combination conversion/intercalation chemistry material is referred to as the positive electrode. In some common usages, cathode is used in place of positive electrode, and anode is used in place of negative electrode. When a Li-secondary battery is charged, Li ions move from the positive electrode (e.g., NiFₓ, NMC, NCA) towards the negative electrode (e.g., Li-metal). When a Li-secondary battery is discharged, Li ions move towards the positive electrode and from the negative electrode.

As used herein, the phrase “porosity as determined by SEM” refers to measurement of density by using image analysis software to analyze a scanning electron micrograph. For example, first, a user or software assigns pixels and/or regions of an image as porosity. Second, the area fraction of those regions is summed. Finally, the porosity fraction determined by SEM is equal to the area fraction of the porous region of the image.

As used herein, the phrase “providing” refers to the provision of, generation or, presentation of, or delivery of that which is provided.

As used herein, the terms “separator,” “solid-state separator” and “Li⁺ ion-conducting separator,” are used interchangeably with separator being a short-hand reference for Li⁺ ion-conducting separator, unless specified otherwise explicitly. A separator refers to a solid electrolyte which conducts Li⁺ ions, is substantially insulating to electrons, and which is suitable for use as a physical barrier or spacer between the positive and negative electrodes in an electrochemical cell or a rechargeable battery. A separator, as used herein, is substantially insulating when the separator's lithium ion conductivity is at least 10³, and typically 10⁶ times, greater than the separator's electron conductivity. A separator can be a film, monolith, or pellet. Unless explicitly specified to the contrary, a separator as used herein is stable when in contact with lithium metal. A separator, as referred to herein, may be a thin film garnet separator such as, for example, a lithium-stuffed garnet thin film. A separator may be a bare film, a co-sintered current collector (CSC) film, or a bilayer film (e.g., wherein the bilayer comprises a metal layer and a lithium-stuffed garnet layer).

As used herein, the phrase “bare film” refers to a sintered separator with no other, metal-containing layers.

As used herein, the phrase “co-sintered current collector film”, “CSC film” or “CSC”, refers to a sintered separator comprising a ceramic layer and a metal-ceramic layer, wherein the ceramic layer and the metal-ceramic layer have been co-sintered. When in the green state, the metal-ceramic layer of the CSC film is a metal and ceramic powder.

As used herein, the phrase “bilayer film”, or “bilayer” refers to a sintered ceramic layer deposited onto a metal layer. A sintered bilayer may have a ceramic layer thickness of 10-50 μm and the metal layer thickness is 1-20 μm thick. The bilayer may have a ceramic layer thickness of 20-30 μm and the metal layer thickness is 3-10 μm thick. The metal layer of the bilayer film does not contain any ceramic material and may be a metal foil. The metal foil may be purchased, and is typically made by processes other than sintering (e.g. electrodeposition or roll-annealing).

As used here, the phrase “solid-state electrolyte,” is used interchangeably with the phrase “solid separator” refers to a material which does not include carbon and which conducts atomic ions (e.g., Li⁺) but does not conduct electrons. An inorganic solid-state electrolyte is a solid material suitable for electrically isolating the positive and negative electrodes of a lithium secondary battery while also providing a conduction pathway for lithium ions. Example inorganic solid-state electrolytes include oxide electrolytes and sulfide electrolytes, which are further defined below. Non-limiting example sulfide electrolytes are found, for example, in U.S. Pat. No. 9,172,114, which issued Oct. 27, 2015, and also in US Patent Application Publication No. 2017-0162901 A1, which published Jun. 8, 2017, and was filed as U.S. patent application Ser. No. 15/367,103 on Dec. 1, 2016, the entire contents of which are herein incorporated by reference in its entirety for all purposes. Non-limiting example oxide electrolytes are found, for example, in US Patent Application Publication No. 2015-0200420 A1, which published Jul. 16, 2015, the entire contents of which are herein incorporated by reference in its entirety for all purposes. In some embodiments, the inorganic solid-state electrolyte also includes a polymer.

As used here, the phrase “sulfide electrolyte,” or “lithium sulfide” includes, but is not limited to, electrolytes referred to herein as LSS, LTS, LXPS, or LXPSO, where X is Si, Ge, Sn, As, Al, or Li—Sn—Si—P—S, or Li—As—Sn—S. In these acronyms (LSS, LTS, LXPS, or LXPSO), S refers to the element S, Si, or combinations thereof, and T refers to the element Sn. “Sulfide electrolyte” may also include LiₐP_{b}S_{c}X_{d}, LiₐB_{b}S_{c}X_{d}, LiₐSn_{b}S_{c}X_{d} or LiₐSi_{b}S_{c}X_{d} where X═F, Cl, Br, I, and 10%≤a≤50%, 10%≤b≤44%, 24%≤c≤70%, 0≤d≤18%; % are atomic %. Up to 10 at % oxygen may be present in the sulfide electrolytes, either by design or as a contaminant species. Non-limiting examples of sulfide electrolytes are found, for example, in U.S. Pat. No. 9,172,114, issued Oct. 27, 2015, and also in US Patent Application Publication No. 2017-0162901 A1, which published Jun. 8, 2017, and was filed as U.S. patent application Ser. No. 15/367,103 on Dec. 1, 2016, the entire contents of which are herein incorporated by reference in its entirety for all purposes. As used herein, a sulfide catholyte is a catholyte that comprises or consists essentially of a sulfide.

As used herein, the term “sulfide-halide” refers to a chemical compound that includes at least one sulfur atom, at least one halogen atom, and one other element in the chemical formula for the chemical compound.

As used herein, voltage is set forth with respect to lithium (i.e., V vs. Li) metal unless stated otherwise.

As used herein, the term “catholyte” refers to an ion conductor that is intimately mixed with, or surrounded by, a cathode (i.e., positive electrode) active material (e.g., a metal fluoride optionally including lithium). Catholytes suitable with embodiments described herein include, but are not limited to, catholytes having the common name Li-stuffed garnets, LPS, LXPS, LATS, or LXPSO, where X is Si, Ge, Sn, As, Al, or combinations thereof. Catholytes may be liquid, gel, semi-liquid, semi-solid, polymer, and/or solid polymer ion conductors. In an example, the catholyte is a high Li⁺ ionic conductivity catholyte. In an example, the catholyte includes sulfide electrolytes, sulfide-halide electrolytes, and combinations thereof.

As used herein, the term “opposite the positive electrode current collector” refers to a configuration being on the opposite side. For example, wherein the solid-state buffer layer in contact with the positive electrode layer and opposite the positive electrode current collector means the positive electrode layer is in contact with one side of the solid-state buffer layer and the positive electrode current collector is in contact with the other (opposite) side of the solid-state buffer layer.

As used herein, the term “thickness of the buffer layer” refers to a buffer layer that is solid as described herein, wherein the solid-state buffer layer is spread across the face of the positive electrolyte layer, bonding layer, and/or solid-state separator. The layer is not limited to a perimeter seal.

As used herein, the term “bonding layer” and “bonding layer is disposed on the face of the solid-state buffer layer” refers to a layer that is both adhesive and conductive. The layer is not limited to a perimeter seal, but includes coating the face of the positive electrode layer, buffer layer, and/or solid-state separator.

As used herein, the term “argyrodite” refers to compositions including Li₇-zPS₆-zX_{z}, wherein X is selected from Cl, Br, I, and combinations thereof, wherein 0<z<2. In an example, the argyrodite can be Li₆PS₅Cl, Li₆PS₅I, Li₆PS₅Br, or combinations thereof.

### Electrochemical Cells

In an aspect, set forth herein is an electrochemical cell comprising: a positive electrode current collector; a positive electrode comprising a catholyte; a solid-state buffer layer in contact with the positive electrode and opposite the positive electrode current collector; a lithium-stuffed garnet electrolyte separator; wherein the thickness of the buffer layer is greater than 0% and less than 50% the thickness of the positive electrode.

In an aspect, set forth herein is an electrochemical cell comprising a positive electrode current collector; a positive electrode comprising a catholyte; a solid-state buffer layer in contact with the positive electrode and opposite the positive electrode current collector; a separator comprising a lithium-stuffed garnet layer and a metal layer; wherein the thickness of the buffer layer is greater than 0% and less than 50% the thickness of the positive electrode.

In some embodiments, including any of the foregoing, the thickness of the buffer layer is greater than 0% and less than 45%, less than 40%, less than 35%, less than 30%, less than 25%, less than 20%, less than 15%, or less than 10% of the thickness of the positive electrode. In some embodiments, including any of the foregoing, the thickness of the buffer layer is between about 0.01% to about 50% of the thickness of the positive electrode. In some embodiments, including any of the foregoing, the thickness of the buffer layer is between about 1% to about 25% of the thickness of the positive electrode. In some embodiments, including any of the foregoing, the thickness of the buffer layer is between about 1% to about 15% of the thickness of the positive electrode. In some embodiments, including any of the foregoing, the thickness of the buffer layer is between about 5% to about 10% of the thickness of the positive electrode.

In an aspect, set forth herein is an electrochemical cell comprising: a positive electrode current collector; a positive electrode comprising a catholyte; a solid-state buffer layer in contact with the positive electrode and opposite the current collector; a lithium-stuffed garnet electrolyte separator; wherein the thickness of the buffer layer is 0.5 μm to 50 μm.

In an aspect, set forth herein is an electrochemical cell comprising: a positive electrode current collector; a positive electrode comprising a catholyte; a solid-state buffer layer in contact with the positive electrode and opposite the current collector; a separator comprising a lithium-stuffed garnet layer and a metal layer; wherein the thickness of the buffer layer is 0.5 μm to 50 μm.

In some embodiments, including any of the foregoing, the thickness of the buffer layer is 1 μm to 50 μm. In some embodiments, including any of the foregoing, the thickness of the buffer layer is 1 μm to 25 μm. In some embodiments, including any of the foregoing, the thickness of the buffer layer is 1 μm to 15 μm. In some embodiments, including any of the foregoing, the thickness of the buffer layer is 5 μm to 15 μm.

In an aspect, set forth herein is a solid-state battery comprising a positive electrode comprising cathode active material, at least one binder, and a catholyte; a solid-state buffer layer disposed on the positive electrode; a bonding layer disposed on the solid-state buffer layer; and a separator disposed on the bonding layer, wherein the separator comprises a lithium-stuffed garnet layer and a metal layer; and wherein the solid-state buffer layer comprises the same material as the catholyte material. In some embodiments, the lithium-stuffed garnet layer of the separator contacts the bonding layer.

In an aspect, set forth herein is a solid-state battery comprising a positive electrode comprising cathode active material, at least one binder, and a catholyte; a solid-state buffer layer disposed on the positive electrode; a bonding layer disposed on the solid-state buffer layer; and a separator disposed on the bonding layer, wherein the separator comprises a lithium-stuffed garnet layer and a metal layer; and wherein the solid-state buffer layer comprises a different material than the catholyte material. In some embodiments, the lithium-stuffed garnet layer of the separator contacts the bonding layer.

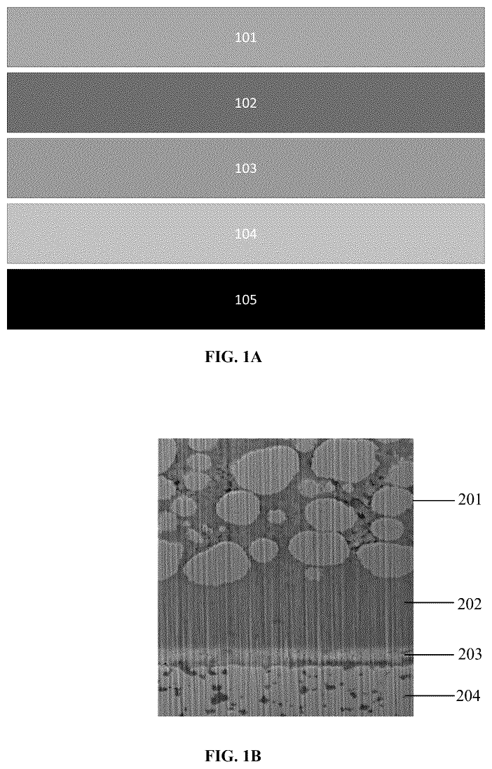

One embodiment of an electrochemical cell is schematically illustrated in FIG. 1. As shown, the solid-state battery can include a positive current collector layer in contact with a positive electrode layer. The positive electrode layer includes a cathode active material, a binder, and a catholyte material. The positive electrode layer can be solvent-free. In some embodiments, the positive electrode layer does not include an additional electronically conductive additive.

In FIG. 1A, layer 101 represents a lithium metal anode. Layer 102 represents a separator layer. In some embodiments, layer 102 is a bare film. Layer 103 represents a bonding layer. Layer 104 represents a buffer layer. Layer 105 represents a positive electrode layer. In some embodiments, layer 102 is approximately 100 μm thick. In some embodiments, layer 101 is approximately 15, 16, 17, 18, 19, 20, 21, 22, 23, 24, 25, 26, 27, 28, 29, 30, 31, 32, 33, 34, 35, 36, 37, 38, 39, or 40 μm thick. In some embodiments, layer 102 is approximately 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, or 125 μm thick. In some embodiments, layer 103 is approximately 1, 2, 3, 4, 5, 6, 7, 8, 9, 10, 11, 12, 13, 14, or 15 μm thick. In some embodiments, layer 104 is approximately 1, 2, 3, 4, 5, 6, 7, 8, 9, 10, 11, 12, 13, 14, or 15 μm thick. In some embodiments, layer 105 is approximately 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, or 170 μm thick.

FIG. 1B is an SEM image of an example of the electrochemical cell disclosed herein. The image shows a positive electrode layer 201 including a cathode active material (NMC) and catholyte material (LPSCl) with PTFE. A buffer layer 202 LSTPS is between the positive electrode layer and the electrolyte separator. The bonding layer 203 of LBHIN adheres the buffer layer to the garnet-based electrolyte separator 204.

The positive electrode layer is in contact with a solid-state buffer layer. In an example, the solid-state buffer layer can comprise the same material as the catholyte of the positive electrode layer. In an example, the solid-state buffer layer can comprise a different material as the catholyte of the positive electrode layer. The solid-state buffer layer can be bound to a separator layer via a bonding layer. The separator layer can be a lithium-stuffed garnet layer. The separator layer can be in contact with a negative current collector.

In some embodiments, including any of the foregoing, the electrochemical cell further includes a positive electrode current collector layer.

In some embodiments, including any of the foregoing, the electrochemical cell further includes a negative electrode current collector layer. In some embodiments, including any of the foregoing, the negative electrode current collector layer is a sintered metal. In some embodiments, including any of the foregoing, the sintered metal is selected from the group consisting of Al, Cu, Ni, Ag, Au, Pt, Pd, or Sn. In some embodiments, including any of the foregoing, the metal is Ni.

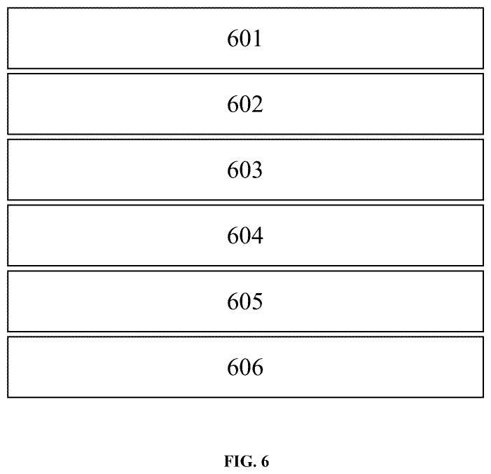

One example of an electrochemical cell is schematically illustrated in FIG. 6. In FIG. 6, layer 601 represents a negative electrode current collector. Layer 602 represents a metal layer. Layer 603 represents a lithium-stuffed garnet layer. In some embodiments, including any of the foregoing, layers 602 and 603 together are a separator bilayer film. Layer 604 represents a bonding layer. Layer 605 represents a buffer layer. Layer 606 represents a positive electrode layer. In some embodiments In some embodiments, including any of the foregoing, layer 601 is approximately 1, 2, 3, 4, 5, 6, 7, 8, 9, 10, 11, 12, 13, 14, 15, 16, 17, 18, 19, or 20 μm thick. In some embodiments, including any of the foregoing, layer 602 is approximately 1, 2, 3, 4, 5, 6, 7, 8, 9, 10, 11, 12, 13, 14, 15, 16, 17, 18, 19, or 20 μm thick. In some embodiments, including any of the foregoing, layer 603 is about 1 μm to about 100 μm or about 1 μm to about 50 μm thick. In some embodiments, including any of the foregoing, layer 603 is approximately 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm thick. In some embodiments, including any of the foregoing, layer 604 is approximately 1, 2, 3, 4, 5, 6, 7, 8, 9, 10, 11, 12, 13, 14, or 15 μm thick. In some embodiments, including any of the foregoing, layer 605 is approximately 1, 2, 3, 4, 5, 6, 7, 8, 9, 10, 11, 12, 13, 14, or 15 μm thick. In some embodiments, including any of the foregoing, layer 606 is approximately 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, or 170 μm thick.

### Cathode Active Material

In some embodiments, including any of the foregoing, including any of the foregoing, the catholyte active material can comprise a lithium intercalation material, a lithium conversion material, or both a lithium intercalation material and a lithium conversion material.

In some embodiments, including any of the foregoing, including any of the foregoing, the intercalation material is selected from the group consisting of a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, and LiMn₂₋ₐNiaO₄, wherein a is from 0 to 2, or LiMPO₄, wherein M is Fe, Ni, Co, or Mn.

In some embodiments, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In some other embodiments, the cathode active material is, or includes, a manganese oxide (MnO), iron oxides, copper oxides, nickel oxides, lithium-manganese complex oxides (e.g., LiₓMn₂O₄ or LiₓMnO₂), lithium-nickel complex oxides (e.g., LiₓNiO₂), lithium-cobalt complex oxides (e.g. LiₓCoO₂), lithium cobalt nickel oxides (LiNi_{1-y}Co_{y}O₂), lithium-manganese-cobalt complex oxides (e.g., LiMn_{y}Co_{1-y}O₂), spinel-phase lithium-manganese-nickel complex oxides (e.g., LiₓMm_{2-y}Ni_{y}O₄), lithium phosphates having an olivine structure (e.g., LiₓFePO₄, LiₓFe_{1-y}Mn_{y}PO₄, LiₓCoPO₄), lithium phosphates having a NASICON-type structure (e.g., Li₇V₂(PO₄)₃), iron (III) sulfate (Fe₂(SO₄)₃), and vanadium oxides (e.g., V₂O₅). In some embodiments, x and y in these chemical formulas lie within the ranges of 1<x<5, and 0<y<1. In some embodiments, the cathode active material is LiCoO₂, LiₓV₂(PO₄)₃, LiNiPO₄, and LiFePO₄. In some embodiments, the cathode active material is doped LiCoO₂, including La-doped LiCoO₂ and Al-doped LiCoO₂.

In some embodiments, including any of the foregoing, the cathode active material is LiNiₓMn_{y}Co_{z}O₂, x+y+z=1, 0.8≤x≤1, 0≤y≤1, and 0≤z≤1 and wherein x+y+z=1.

In some embodiments, including any of the foregoing, the cathode active material is LiNiₓMn_{y}Co_{z}O₂ and either (a)-(e):
(a) x is 0.8, y is 0.1, and z is 0.1;
(b) 0.8≤x≤0.97, 0≤y≤0.2, and 0≤z≤0.2;
(c) 0.8≤x≤0.90, 0≤y≤0.2, and 0≤z≤0.2;
(d) 0.8≤x≤0.85, 0≤y≤0.2, and 0≤z≤0.2; or
(e) 0.8≤x≤0.83, 0≤y≤0.2, and 0≤z≤0.2.

In the above formulas, the sum of x, y, and z is 1.

In some embodiments, including any of the foregoing, the lithium conversion material is selected from the group consisting of FeF₂, NiF₂, FeOxF₃₋₂ₓ, FeF₃, MnF₃, CoF₃, CuF₂ materials, alloys thereof, and combinations thereof, or LiMPO₄, wherein M is Fe, Ni, Co, or Mn.

In some embodiments, including any of the foregoing, the cathode active material includes a coating or the active material is coated. In some embodiments, including any of the foregoing, the active material has a coating. In some embodiments, including any of the foregoing, the active material is coated. In some embodiments, including any of the foregoing, the active material includes a coating of a material selected from lithium-lanthanum-zirconium oxide (LLZO).

In some embodiments, including any of the foregoing, the cathode active material is coated or partially coated with a coating selected from the group consisting of lithium niobium oxide (LNO), lithium zirconium oxide (LZO), lithium zirconium phosphate (LZP), lithium aluminum oxide (LAO), lithium phosphate (LPO), lithium titanium oxide (LTO), lithium tantalum oxide (LTaO), lithium borate (LBO), lithium sulfate (LSO), lithium carbonate (LCO), lithium indium chloride (LInCl), lithium silicate (LSiO), lithium zirconium fluoride (LZF), lithium titanium fluoride (LTF), lithium aluminum fluoride (LAF), lithium yttrium fluoride (LYF), lithium niobium fluoride (LNF), lithium hafnium oxide (LHO), lithium hydroxide, lithium fluoride, lithium bromide, lithium iodide, titanium oxide, titanium fluoride, yttrium fluoride, niobium oxide, niobium fluoride, zirconium oxide, zirconium fluoride, aluminum oxide, aluminum fluoride, tantalum oxide, and hafnium oxide.

In an example, the coating comprises LZO, LZP, LBO, LPO, LSiO, LInCl, or combinations thereof. In an example, the coating comprises LZO. In an example, the coating comprises LZP. In an example, the coating comprises LBO. In an example, the coating comprises LPO. In an example, the coating comprises LSiO. In an example, the coating comprises LInCl.

In some embodiments, including any of the foregoing, the cathode active material comprises a dual coating. In some embodiments, including any of the foregoing, the dual coating comprises a first coating and a second coating, wherein the first coating is in contact with the active material and the second coating is in contact with the first coating.

In an example, the coating is a dual coating of LZO/LCO, LZP/LCO, LBO/LCO, LPO/LCO, LSiO/LCO, LInCl/LCO, or LSO/LCO. In an example, the coating is a dual coating of LZO/LBO, LZO/LZP, LZO/LPO, or LZO/LInCl. In an example, the coating is a dual coating of LBO/LSO or LPO/LBO.

The coating thickness can be 0.1 nm to 50 nm. In an example, the coating thickness is 2 nm to 10 nm.

In some embodiments, including any of the foregoing, the coating has a thickness, T, as determined by TEM analysis, of about 1 nm≤T≤20 nm. In some embodiments, including any of the foregoing, the coating has a thickness, T, as determined by TEM analysis, of about 1 nm≤T≤10 nm. In some embodiments, including any of the foregoing, the coating has a thickness, T, as determined by TEM analysis, of about 1 nm≤T≤3 nm.

In some embodiments, including any of the foregoing, the coating is continuous. In some embodiments, including any of the foregoing, the coating is discontinuous. In some embodiments, including any of the foregoing, the coating is a discontinuous layer. In some embodiments, including any of the foregoing, the coating is a continuous layer.

In some embodiments, including any of the foregoing, the coating is amorphous. In some embodiments, including any of the foregoing, the coating is crystalline. In some embodiments, including any of the foregoing, the coating comprises crystalline domains as determined by TEM analysis. In some embodiments, including any of the foregoing, the coating comprises amorphous domains as determined by TEM analysis. In some embodiments, including any of the foregoing, the coating comprises crystalline domains and amorphous domains as determined by TEM analysis. In some embodiments, including any of the foregoing, the crystalline domains are in contact with the cathode active material. In some embodiments, including any of the foregoing, the amorphous domains are in contact with the cathode active material.

In some embodiments, including any of the foregoing, the cathode active material coating may be any coating described in WO/2023/114436, published on Jun. 22, 2023, titled CATHODE MATERIALS HAVING OXIDE SURFACE SPECIES, the entire contents of which are herein incorporated by reference. In some embodiments, including any of the foregoing, the cathode active material coating may be any coating described in WO/2024/263602, published on Dec. 26, 2024, titled CATHODE ACTIVE MATERIALS HAVING LITHIUM PHOSPHATE SURFACE SPECIES, the entire contents of which are herein incorporated by reference. In some embodiments, including any of the foregoing, the cathode active material coating may be any coating described in WO 2022/056039, published on Mar. 17, 2022, titled CATHODE COATING, the entire contents of which are herein incorporated by reference.

In some embodiments, including any of the foregoing, the coating comprises a compound of the formula LiₓZr_{y}PₐO_{d}, wherein 0.05≤x≤25.0, 0≤y≤5.0, 0≤a≤16.0; and 2.0≤d≤55.0, wherein the formula is charge neutral.

In some embodiments, including any of the foregoing, the coating comprises a compound of the formula, LiₓZr_{y}O_{z}, wherein 0≤x≤1.6, 0.2≤y≤1.0, and 1.2≤z≤2, wherein the formula is charge neutral.

In some embodiments, including any of the foregoing, the coating comprises a compound of the formula LiₓPaO_{d}, wherein 0.05≤x≤1.5, 1.0≤a≤6.0, and 2.0≤d≤20.0 and wherein the formula is charge neutral. In some embodiments, including any of the foregoing, the coating comprises a compound of the formula LiₓPaO_{d}, wherein 0.5≤x≤7.0, 1.0≤a≤4.0, and 5.0≤d≤14.0, wherein the formula is charge neutral.

In certain embodiments, including any of the foregoing, the coating comprises a compound of the chemical formula: LiₓB_{y}O_{z}, wherein 0.2≤x≤0.75, 0.5≤y≤1.6, and 1.5≤z≤2.6; LiₓC_{y}O_{z}, wherein 0.4≤x≤1.8, 0.1≤y≤1, and 1≤z≤1.8; LiₓZr_{y}O_{z}, wherein 0≤x≤1.6, 0.2≤y≤1.0, and 1.2≤z≤2; LiₓP_{y}O_{z}, wherein 0.6≤x≤1.5, 0.5≤y≤1.4, and 2.0≤z≤3.7; LiₓZr_{y}(PO₄)_{z}, wherein 0.05≤x≤1.5, 1≤y≤3, and 2.0≤z≤4.0; LiₓNb_{y}O_{z}, wherein 0.5≤x≤1.5, 0.5≤y≤1.5, and 2≤z≤4; LiₓTi_{y}O_{z}, wherein 0≤x≤1.6, 0.2≤y≤1.0, and 2≤z≤1.2; LiₓTi_{y}P_{w}O_{z}, wherein 0≤x≤2, 1≤y≤3, 1≤w≤4, and 2≤z≤20; LiₓZr_{y}P_{w}O_{z}, wherein 0≤x≤2, 1≤y≤3, 1≤w≤4, and 2≤z≤20; LiₓZr_{y}F_{z}, wherein 0.2≤x≤0.75, 0.25≤y≤0.8, and 1.75≤z≤3.4; LiₓTi_{y}F_{z}, wherein 0.2≤x≤0.75, 0.25≤y≤0.8, and 1.75≤z≤3.4; _{LixAlyFz}, wherein 0.4≤x≤0.8, 0.2≤y≤0.6, and 1.4≤z≤2.2; LiₓY_{y}F_{z}, wherein 0.4≤x≤0.8, 0.2≤y≤0.6, and 1.4≤z≤2.2; LiₓNb_{y}F_{z}, wherein 0.2≤x≤0.8, 0.2≤y≤0.8, and 1.8≤z≤4.2; or combinations thereof. Subscripts x, y, and z, are selected so the compound is charge neutral.

In some embodiments, including any of the foregoing, the coating comprises Li₂CO₃, Li₃BO₃, Li₃B₁₁O₁₈, Li₂ZrO₃, Li₃PO₄, LiPO₃, Li₄P₂O₇, a lithium organophosphate, LiZr₂(PO₄)₃, Li₃ZrPO₆, Li₅PZrO₇, Li₇ZrPO₈, Li₂₄Zr₃P₁₄O₅₃, Li₂SO₄, LiNbO₃, Li₄Ti₅O₁₂, LiTi₂(PO₄)₃, LiOH, LiZO, LIF, Li₄ZrF₈, Li₃Zr₄F₁₉, Li₃TiF₆, LiAlF₄, LiYF₄, LiNbF₆, ZrO₂, Al₂O₃, TiO₂, ZrF₄, AlF₃, TiF₄, YF₃, NbF₅, Li₃InCl₆, Li₂SiO₃, or combinations thereof.

In an example, the coating comprises Li₂CO₃. In an example, the coating comprises Li₃BO₃. In an example, the coating comprises Li₃B₁₁O₁₈. In an example, the coating comprises Li₂ZrO₃. In an example, the coating comprises Li₃PO₄. In an example, the coating comprises LiPO₃. In an example, the coating comprises Li₄P₂O₇. In an example, the coating comprises a lithium organophosphate. In an example, the coating comprises LiZr₂(PO₄)₃. In an example, the coating comprises Li₃ZrPO₆. In an example, the coating comprises Li₅PZrO₇. In an example, the coating comprises Li₇ZrPO₈. In an example, the coating comprises Li₂₄Zr₃P₁₄O₅₃. In an example, the coating comprises Li₂SO₄. In an example, the coating comprises LiNbO₃. In an example, the coating comprises Li₄Ti₅O₁₂. In an example, the coating comprises LiTi₂(PO₄)₃. In an example, the coating comprises LiOH. In an example, the coating comprises Li₂O. In an example, the coating comprises LiF. In an example, the coating comprises Li₄ZrF₈. In an example, the coating comprises Li₃Zr₄F₁₉. In an example, the coating comprises Li₃TiF₆. In an example, the coating comprises LiAlF₄. In an example, the coating comprises LiYF₄. In an example, the coating comprises LiNbF₆. In an example, the coating comprises ZrO₂. In an example, the coating comprises Al₂O₃. In an example, the coating comprises TiO. In an example, the coating comprises ZrF₄. In an example, the coating comprises AlF₃. In an example, the coating comprises TiF₄. In an example, the coating comprises YF₃. In an example, the coating comprises NbF₅. In an example, the coating comprises Li₃InCl₆. In an example, the coating comprises Li₂SiO₃.

In some embodiments, including any of the foregoing, the lithium organophosphate is lithium diethylphosphate, lithium dimethylphosphate, lithium diisopropylphosphate, lithium ethyl methyl phosphate, lithium ethyl isopropyl phosphate, lithium methyl isopropyl phosphate, dilithium methylphosphate, dilithium ethylphosphate, dilithium isopropylphosphate, or combinations thereof.

In some embodiments, including any of the foregoing, the coated NMC can include a core of high Ni to Co, Ni, Mn that is greater than 0.6 mol %. In some embodiments, including any of the foregoing, the coated NMC can include a core of high Ni to Co, Ni, Mn that is greater than 0.8 mol %. In some embodiments, including any of the foregoing, the coated NMC can include at least 80% by mole of Ni.

The core particle size D₅₀ can be from 1 μm to 8 μm. In an example, the D₅₀ of the core particle can be 4 μm. The core can be polymeric or monomeric.

In some embodiments, including any of the foregoing, the cathode active material includes at least 80% by mole of Ni and has a mono-modal particle size.

In some embodiments, including any of the foregoing, the cathode active material includes at least 80% by mole of Ni and has a D₉₀ particle size of 1 to 10 microns (μm).

In some embodiments, including any of the foregoing, the cathode active material includes at least 80% by mole of Ni and has a D₉₀ particle size of about 4 microns.

In some embodiments, including any of the foregoing, the cathode active material includes at least 80% by mole of Ni and has a D₉₀ particle size of about 3.8 μm.

In some embodiments, including any of the foregoing, the cathode active material includes at least 80% by mole of Ni and has a D₉₀ particle size of about 3.2 μm.

In some embodiments, the cathode active material is LiNiₓMn_{y}Co_{z}O₂, x+y+z=1, 0≤x≤1, 0≤y≤1, and 0≤z≤1 and comprises particles with a diameter of about 1 μm to 20 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 1 μm to 15 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 1 μm to 10 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 1 μm to 9 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 1 μm to 8 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 2 μm to 7 μm as measured by TEM. In some embodiments, the cathode active material is LiNiₓMn_{y}Co_{z}O₂, x+y+z=1, 0≤x≤1, 0≤y≤1, and 0≤z≤1 and comprises particles with a diameter of about 2 μm to 5 μm as measured by TEM.

In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 1 μm to 20 μm as measured by TEM. In some embodiments, the cathode active material is LiNiₓMn_{y}Co_{z}O₂, x+y+z=1, 0.80≤x≤1, 0≤y≤1, and 0<z≤1, wherein x+y+z=1 and comprises particles with a diameter of about 1 μm to 15 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 1 μm to 10 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 1 μm to 9 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 1 μm to 8 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 2 μm to 7 μm as measured by TEM. In some embodiments, the cathode active material is LiNiₓMn_{y}Co_{z}O₂, x+y+z=1, 0.80≤x≤1, 0≤y≤1, and 0≤z≤1, wherein x+y+z=1 and comprises particles with a diameter of about 2 μm to 5 μm as measured by TEM.

In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 1 μm to 20 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 1 μm to 15 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 1 μm to 10 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 1 μm to 9 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 1 μm to 8 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 2 μm to 7 μm as measured by TEM. In some embodiments, the cathode active material is LiNiₓMn_{y}Co_{z}O₂, x+y+z=1, 0.80≤x≤0.90, 0≤y≤0.2, and 0≤z≤0.2, wherein x+y+z=1 and comprises particles with a diameter of about 2 μm to 5 μm as measured by TEM.

In some embodiments, the cathode active material is doped with zirconium. In some embodiments, the cathode active material is Zr-doped LiNiₓMn_{y}Co_{z}O₂, x+y+z=1, 0.8≤x≤1, 0≤y≤1, and 0≤z≤1, wherein x+y+z=1. In some embodiments, the cathode active material is Zr-doped LiNiₓMn_{y}Co_{z}O₂, x+y+z=1, 0.80≤x≤0.90, 0≤y≤0.2, and 0≤z≤0.2, wherein x+y+z=1.

The coating can have a thickness of 0.1 nm to 50 nm. In some embodiments, including any of the foregoing, the cathode active material is uncoated.

The cathode active material can have a particle size having a D₅₀ of 1 μm to 8 μm.

### Binder

In some embodiments, including any of the foregoing, the positive electrolyte layer, the buffer layer, or both, comprises a binder at 0.01 to 10% by weight. Binders may include, In some embodiments, polyolefins. Binders may include ethylene alpha-olefin copolymer, ethylene-octene copolymer, polyolefin plastomers, polyolefin elastomers, styrene-butadiene rubber, polyvinylidene fluoride, poly(vinylidene fluoride-co-hexafluoropropylene), and the like.

In some embodiments, including any of the foregoing, the positive electrode layer, solid-state buffer layer, or both, comprises an organic polymer at 10% by volume or less.

In some embodiments, including any of the foregoing, the polymer is selected from the group consisting of polyacrylonitrile (PAN), polypropylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide 2-methoxyethoxy)ethyl glycidyl ether (PEO-MEEGE), polyethylene oxide 2-methoxyethoxy)ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), polyethyl acrylate (PEA), polyvinylidene fluoride (PVDF), polyethylene, polytetrafluoroethylene (PTFE), and combinations thereof. In an example, the binder is PTFE. In an example, the binder is a mixture of PVDF/PTFE.

In some embodiments, including any of the foregoing, the buffer layer does not include an organic polymer.

### Catholyte

The positive layer electrolyte, the solid-state buffer layer, or both can include a catholyte. In an example, the catholyte includes a catholyte of LiₓPₓS_{y}Cl_{z}, wherein 0<w<13, 0<x<3, 0<y<12, and 0<z<10; Li_{w}PₓS_{y}X_{z}, wherein 0<w<13, 0<x<3, 0<y<12, and 0<z<10, and wherein X is Co, Br, or I; Li_{w}MₓM′_{y}P_{z}Sᵥ, wherein 0<w<20, 0<x<1, 0<y<1, 0<z<4, 0<v<12, and wherein M and M′ are independently Si, Ge, or Sn; or combinations thereof.

In some embodiments, the catholyte can be characterized by one of the following formula: LiₐSi_{b}Sn_{c}P_{d}SₑO_{f}, wherein 2≤a≤8, 0≤b≤1, 0≤c≤1, b+c=1, 0.5≤d≤2.5, 4≤e≤12, and 0≤f≤10; LiₐSi_{b}P_{c}S_{d}Xₑ, wherein 8<a<12, 1<b<3, 1<c<3, 8<d<14, and 0<e<1, wherein X is F, Cl, Br, or I; Li_{g}AsₕSnⱼSₖOₗ, wherein 2≤g≤6, 0≤h≤1, 0≤j≤1, 2≤k≤6, and 0≤l≤10; LiₘPₙSₚI_{q}, wherein 2≤m≤6, 0≤n≤1, 0≤p≤1, 2≤q≤6; a mixture of (Li₂S):(P₂S₅) having a molar ratio of Li₂S:P₂S₅ from about 10:1 to about 6:4 and LiI, wherein the ratio of [(Li₂S):(P₂S₅)]:LiI is from 95:5 to 50:50; LPS+X, wherein X is selected from Cl, I, or Br; vLi₂S+wP₂S₅+yLiX; or vLi₂S+wSiS₂+yLiX. In some embodiments, including any of the foregoing, the sulfide catholyte comprises LSTPS·₂S+wB₂S₃+yLiX.

In some embodiments, the catholyte comprises LiₐSi_{b}Sn_{c}P_{d}Sₑ, wherein 2≤a≤8, 0≤b≤1, 0≤c≤1, 0.5≤d≤2.5, and 4≤e≤12. In some embodiments, the buffer comprises LiₐSi_{b}Sn_{c}P_{d}Sₑ, wherein 2≤a≤8, 0≤b≤1, 0≤c≤1, b+c=1, 0.5≤d≤2.5, and 4≤e≤12. In some embodiments, the catholyte comprises LiₐSi_{b}Sn_{c}P_{d}Sₑ, wherein 3≤a≤7, 0≤b≤1, 0≤c≤1, b+c=1, 0.5≤d≤1.5, and 8≤e≤12. In some embodiments, the buffer comprises LiₐSi_{b}Sn_{c}P_{d}Sₑ, wherein 3≤a≤5, 0≤b≤1, 0≤c≤1, b+c=1, 0.5≤d≤1, and 5≤e≤9. In some embodiments, the catholyte comprises LiₐSi_{b}Sn_{c}P_{d}Sₑ, wherein 3≤a≤5, 0≤b≤1, 0≤c≤1, b+c=1, 0.5≤d≤1, and 5≤e≤9. In some embodiments, the catholyte comprises LiₐSi_{b}Sn_{c}P_{d}Sₑ, wherein 2≤a≤8, 0≤b≤1, 0≤c≤1, b+c=1, 0.5≤d≤2.5, and 4≤e≤12. In some embodiments, the catholyte comprises LiₐSi_{b}Sn_{c}P_{d}Sₑ, wherein 3≤a≤5, 0≤b≤0.5, 0≤c≤0.5, 0≤d≤2, and 2≤e≤10. In some embodiments, the buffer comprises LiₐSi_{b}Sn_{c}P_{d}Sₑ, wherein 3≤a≤5, 0≤b≤0.25, 0≤c≤1, 0≤d≤1, and 2≤e≤14. In some embodiments, the catholyte comprises LiₐSi_{b}Sn_{c}P_{d}Sₑ, wherein 3≤a≤5, 0≤b≤0.25, 0≤c≤1, 0≤d≤1, and 2≤e≤8.

In some embodiments, the catholyte is selected from the group consisting of LSS, SLOPS, LSTPS, LSTPSCl, SLOBS, LATS, and LPS+X, wherein X is selected from the group consisting of Cl, I, Br, and combinations thereof. In some embodiments, X is Cl. In some embodiments, X is I. In some embodiments, X is Br.

In some embodiments, including any of the foregoing, the catholyte is selected from the group consisting of LSS, SLOPS, LSTPS, LSTPSCl, LSPSCl, SLOBS, LATS, and LPS+X, wherein X is selected from the group consisting of Cl, I, Br, and combinations thereof. In some embodiments, X is Cl. In some embodiments, X is I. In some embodiments, X is Br.

In some embodiments, including any of the foregoing, the catholyte is selected from the group consisting of LPSI, LXPS, LSTPS, LSPSCl, LPSCl, LSPSBr, and LPSBr.

In some embodiments, including any of the foregoing, the catholyte is selected from x·Li₂S:y·SiS₂, wherein x and y are each independently a number from 0 to 1, and wherein x+y=1.

In some embodiments, including any of the foregoing, the catholyte is selected from the group consisting of LSS, LGPS, LSTPS, and LSPS·₂S:y·SiS₂, wherein x and y are each independently a number from 0 to 1, and wherein x+y=1.

### Solid-State Buffer Layer

The solid-state buffer layer can comprise the catholyte material within the positive electrode layer. In some embodiments, the solid-state buffer layer and the positive electrode layer are configured in such a way such that a gradient of cathode active material and the catholyte material is achieved.

In some embodiments, including any of the foregoing, the solid-state buffer is a layer in contact with the positive electrode layer.

In some embodiments, including any of the foregoing, the solid-state buffer is mixed within the positive electrode layer and is present as a layer in contact with the positive electrode layer.

In some embodiments, including any of the foregoing, solid-state buffer layer prevents the bonding layer from contacting the positive electrode layer. In some embodiments, the solid-state bonding layer adheres the lithium-stuffed garnet layer to the buffer layer. In some embodiments, the bonding layer adheres the lithium-stuffed garnet layer to the buffer layer. In some embodiments, the solid-state bonding layer adheres the separator layer to the buffer layer. In some embodiments, the bonding layer adheres the separator layer to the buffer layer.

In some embodiments, including any of the foregoing, the negative electrode layer is between and in contact with the lithium-stuffed garnet layer and the negative electrode current collector layer. In some embodiments, including any of the foregoing, the negative electrode layer is between and in contact with the separator layer and the negative electrode current collector layer. In some embodiments, including any of the foregoing, the buffer layer potential is shielded from the Li metal negative electrode potential.

The solid-state buffer layer can comprise a catholyte material. The catholyte material in the solid-state buffer layer can be the same or different than that of the positive electrode layer.

In some embodiments, including any of the foregoing, the solid-state buffer layer comprises LSTPS. In some embodiments, including any of the foregoing, the solid-state buffer layer comprises LPSCl.

The buffer layer does not conduct electrons and thereby shields the positive electrode potential from the potential experienced by the bonding layer.

The buffer layer does not conduct electrons and thereby shields the positive electrode potential from the potential experienced by the negative electrode.

In some embodiments, the buffer layer is easy to deform.

In some embodiments, the buffer layer is chemically stable when in contact with the sulfide catholyte disclosed herein and/or the and coated active materials, disclosed herein.

In some embodiments, the buffer layer comprises particles with D₅₀ of about 10 nm to about 1000 nm, about 100 nm to about 500 nm, or about 150 nm to about 300 nm. In some embodiments, the buffer layer comprises particles with D₅₀ of about 100 nm, about 200 nm, or about 300 nm. In some embodiments, the buffer layer comprises particles with D₉₀ of about 500 nm to about 2000 nm, about 750 nm to about 1000 nm, or about 1000 nm. In some embodiments, the buffer layer comprises particles with D₉₀ of about 800 nm, about 900 nm, about 1000 nm, or about 1100 nm. In some embodiments, the buffer layer comprises particles with Doo of at least about 750 nm. In some embodiments, the buffer layer comprises particles with D₉₀ of at least about 900 nm.

In some embodiments, the buffer layer comprises particles with D₅₀ of about 0.01 nm to about 200 nm, 0.01 nm to about 150 nm, 0.01 nm to about 100 nm, 0.01 nm to about 75 nm, about 0.01 nm to about 50 nm, about 5 nm to about 50 nm, about 10 nm to about 50 nm, or about 10 nm to about 100 nm.

In some embodiments, the buffer layer comprises particles with D₉₀ of about 10 nm to about 200 nm, about 10 nm to about 150 nm, about 10 nm to about 100 nm, about 25 nm to about 100 nm, about 50 nm to about 100 nm, about 50 nm to about 90 nm, about 50 nm to about 80 nm, or about 60 nm to about 80 nm.

In an example, the thickness of the solid-state buffer layer is less than 50% the thickness of the positive electrode.

In some embodiments, including any of the foregoing, the thickness of the buffer layer is greater than 0% and less than 45%, less than 40%, less than 35%, less than 30%, less than 25%, less than 20%, less than 15%, or less than 10% of the thickness of the positive electrode. In some embodiments, including any of the foregoing, the thickness of the buffer layer is between about 0.01% to about 50% of the thickness of the positive electrode. In some embodiments, including any of the foregoing, the thickness of the buffer layer is between about 1% to about 25% of the thickness of the positive electrode. In some embodiments, including any of the foregoing, the thickness of the buffer layer is between about 1% to about 15% of the thickness of the positive electrode. In some embodiments, including any of the foregoing, the thickness of the buffer layer is between about 5% to about 10% of the thickness of the positive electrode.

In an example, the thickness of the solid-state buffer layer is 0.5 μm to 50 μm. In some embodiments, including any of the foregoing, the thickness of the buffer layer is 1 μm to 50 μm. In some embodiments, including any of the foregoing, the thickness of the buffer layer is 1 μm to 25 μm. In some embodiments, including any of the foregoing, the thickness of the buffer layer is 1 μm to 15 μm. In some embodiments, including any of the foregoing, the thickness of the buffer layer is 5 μm to 15 μm.

In some embodiments, the buffer layer is made of particles 1/10 of the thickness the buffer layer. For example, if the buffer layer is 5 μm thick, then it, in some embodiments, includes buffer particles that are 0.5 μm. In some embodiments, if the buffer layer is 5 μm thick, then the buffer layer includes LSTPS or LPSCl particles that have a d₅₀ particle size diameter of 0.5 μm.

In some embodiments, the buffer layer has negligible interfacial resistance to the positive electrode.

In some embodiments, the buffer layer is non-polymeric, which means it includes less than 5 wt. % polymer.

In some embodiments, the buffer layer is adhered to the positive electrode through a lamination and densification process. This results in a buffered positive electrode which blocks electron access and shields the other electrolyte layer from the positive electrode potential.

In some embodiments, the buffer layer is adhered to the positive electrode through a lamination and densification process. This results in a buffered positive electrode which blocks electron access and shields the other electrolyte layer from the positive electrode potential.

In some embodiments, the buffer layer has a porosity less than about 20% v/v, about 15% v/v, about 12.5% v/v, about 10% v/v, about 5% v/v, about 1% v/v, or less. In some embodiments, the buffer layer has a porosity of about 5% v/v to about 20% v/v, or about 10% v/v to about 15% v/v. In some embodiments, the buffer layer has a porosity of about 0.01% v/v to about 10% v/v, or about 0.01% v/v to about 5% v/v, or about 0.01% v/v to 1% v/v.

In some embodiments, the sulfide in the buffer layer may be any sulfide set forth in US Patent Application Publication No. 2017-0005367 A1, entitled COMPOSITE ELECTROLYTES, which published Jan. 5, 2017, the entire contents of which are herein incorporated by reference in their entirety for all purposes.

The sulfide in the buffer layer in some embodiments may be any sulfide set forth in WO2017096088A1, which published Jun. 8, 2017, and was filed as International PCT Patent Application NO. PCT/US2016/064492, filed Dec. 1, 2016, and entitled LITHIUM, PHOSPHORUS, SULFUR, AND IODINE CONTAINING ELECTROLYTE AND CATHOLYTE COMPOSITIONS, ELECTROLYTE MEMBRANES FOR ELECTROCHEMICAL DEVICES, AND ANNEALING METHODS OF MAKING THESE ELECTROLYTES AND CATHOLYTES, and which published as WO 2017/096088 on Jun. 8, 2017, the entire contents of which are herein incorporated by reference in their entirety for all purposes.

### Bonding Layer Composition

In certain embodiments, a bonding layer may include a composition having A·(LiBH₄)·B·(LiX)·C·(LiNH₂) wherein X may be fluorine, bromine, chloride, iodine, or a combination thereof, and wherein 1≤A≤6, 2≤B≤5, and 0≤C≤9. In some embodiments, a bonding layer comprises A·(LiBH₄)·B·(LiX)·C·(LiNH₂), wherein 3≤A≤6, 2≤B≤5, and 3≤C≤6. In some embodiments, a bonding layer comprises A·(LiBH₄)·B·(LiX)·C·(LiNH₂), wherein 3≤A≤5, 2≤B≤5, and 3≤C≤5. In some embodiments, a bonding layer comprises A·(LiBH₄)·B·(LiX)·C·(LiNH₂), wherein 3≤A≤4, 2≤B≤4, and 3≤C≤4. In some embodiments, a bonding layer comprises A·(LiBH₄)·B·(LiX)·C·(LiNH₂), wherein 4≤A≤5, 2≤B≤4, and 4≤C≤5. In some embodiments, a bonding layer comprises A·(LiBH₄)·B·(LiX)·C·(LiNH₂), wherein 4≤A≤5, 3≤B≤4, and 4≤C≤5. In certain embodiments, a bonding layer may include a composition having A·(LiBH₄)·B·(LiX)·C·(LiNH₂) wherein X may be fluorine, bromine, chloride, iodine, or a combination thereof, and wherein 0.1≤A≤4, 0.1≤B≤4.5, and 0≤C≤9.

In one embodiment, X may be bromine, chlorine, iodine, or a combination thereof. In another embodiment, X may be iodine. In some embodiments, A is 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9 or 4.0. In some embodiments, B is 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, or 4.5. In some embodiments, C is 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9. 8.0, 8.1, 8.2, 8.3, 8.4, 8.5, 8.6, 8.7, 8.8, 8.9, or 9.0.

In some embodiments, the bonding layer comprises a composition comprising A·(LiBH₄)·B·(LiX)·C·(LiNH₂), wherein 2.5<A<4.5, 2.5<B<5.5, and 4<C<9. In some embodiments, including any of the foregoing, the bonding layer comprises a borohydride composition including A·(LiBH₄)·B·(LiX)·C·(LiNH₂). In some embodiments, 2.5<A<3.5, 3.5<B<4.5, and 5<C<9.

In some embodiments, the bonding layer comprises a composition comprising A·(LiBH₄)·B·(LiX)·C·(LiNH₂), wherein A=2, B=1, C=2; A=3, B=2, C=3; A=3, B=3, C=4; A=1, B=1, C=3; A=3.3, B=1.4, C=5.3; A=3, B=1, C=2; or combinations thereof.

In some embodiments, including any of the foregoing, the bonding layer comprises a composition, wherein the composition is 3LiBH₄·2LiCl·3LiNH₂ or 3LiBH₄·4LiCl·9LiNH₂. In one embodiment, the composition may be 3LiBH₄·2LiI·3LiNH₂. In another embodiment, the composition may be 3LiBH₄·4LiI·9LiNH₂. In another embodiment, the composition may be 3LiBH₄·2LiCl·3LiNH₂. In another embodiment, the composition may be 3LiBH₄·4LiCl·9LiNH₂. In another embodiment, the composition may be 3LiBH₄·2LiBr·3LiNH₂. In another embodiment, the composition may be 3LiBH₄·4LiBr·9LiNH₂. In another embodiment, the composition may be 3LiBH₄·1LiBr·2LiNH₂.

In some embodiments, including any of the foregoing, the bonding layer comprises a composition, wherein the composition is 3LiBH₄·2LiCl·3LiNH₂ or 3LiBH₄·4LiCl·5LiNH₂. In one embodiment, the composition may be 4LiBH₄·2LiI·4LiNH₂. In another embodiment, the composition may be 4LiBH₄·3LiI·4LiNH₂. In another embodiment, the composition may be 4LiBH₄·5LiCl·4LiNH₂. In another embodiment, the composition may be 4LiBH₄·6LiCl·4LiNH₂. In some embodiments, including any of the foregoing, the bonding layer comprises a borohydride composition, wherein the composition is 3LiBH₄·3LiCl·4LiNH₂ or 3LiBH₄·3LiCl·5LiNH₂. In one embodiment, the composition may be 3LiBH₄·3LiI·6LiNH₂. In another embodiment, the composition may be 3LiBH₄·3LiI·7LiNH₂.

In some embodiments, including any of the foregoing, the bonding layer comprises a composition selected from LBHIN and LBHN. In some embodiments, including any of the foregoing, the bonding layer comprises KBH₄ and LiNH₂.

In some embodiments, the composition may exist in different physical states. For example, in one embodiment, the composition may be amorphous. By way of further example, in one embodiment, the composition may be semi-crystalline. The composition can be made amorphous or semi-crystalline by controlling the sintering profile, e.g., by adjusting the cooling rate after sintering.

In certain embodiments, the LBHI composition may exist as a film, a single entity, or a pellet. For example, in one embodiment, the composition is a thin film. By way of further example, in one embodiment, the composition is a monolith. By way of further example, in one embodiment, the composition is a pressed pellet.

In some embodiments, the LBHI composition may further include an oxide, a sulfide, a sulfide-halide, or an electrolyte. For example, in one embodiment, the oxide may be selected from a lithium-stuffed garnet characterized by the formula LiₓLa_{y}Zr_{z}Oₜ·qAl₂O₃, wherein 4<x<10, 1<y<4, 1<z<3, 6<t<14, 0≤q≤1. By way of further example, in one embodiment, the composition includes an oxide with a coating of LBHI, where the oxide may be selected from a lithium-stuffed garnet characterized by the formula LiₓLa_{y}Zr_{z}Oₜ·qAl₂O₃, wherein 4<x<10, 1<y<4, 1<z<3, 6<t<14, 0≤q≤1. By way of further example, in one embodiment, the oxide may be selected from a lithium-stuffed garnet characterized by the formula LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Nb, Ga, Ta, or combinations thereof. By way of further example, in one embodiment, the composition includes an oxide with a coating of LBHI, where the oxide may be selected from a lithium-stuffed garnet characterized by the formula LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Nb, Ga, Ta, or combinations thereof. By way of further example, in one LiₐLa_{b}Zr_{c}Al_{d}Me″ₑO_{f} embodiment as above, Me″ is Nb. By way of further example, in one LiₐLa_{b}Zr_{c}Al_{d}Me″ₑO_{f} embodiment as above, Me″ is Ga. By way of further example, in one LiₐLa_{b}Zr_{c}Al_{d}Me″ₑO_{f} embodiment as above, Me″ is Ta. By way of further example, in one LiₐLa_{b}Zr_{c}Al_{d}Me″ₑO_{f} embodiment as above, Me″ is Nb and Ga. By way of further example, in one LiₐLa_{b}Zr_{c}Al_{d}Me″ₑO_{f} embodiment as above, Me″ is Nb and Ta. By way of further example, in one LiₐLa_{b}Zr_{c}Al_{d}Me″ₑO_{f} embodiment as above, Me″ is Ga and Ta.

The bonding layer is in some embodiments made of a borohydride compound. The borohydride compound may be any compound set forth in WO 2018/075972, which published Apr. 26, 2018, and was filed as International PCT Patent Application No. PCT/US2017/057735, and is entitled ELECTROLYTE SEPARATORS INCLUDING LITHIUM BOROHYDRIDE AND COMPOSITE ELECTROLYTE SEPARATORS O_{F} LITHIUM-STUFFED GARNET AND LITHIUM BOROHYDRIDE. The borohydride may be any compound set forth in WO 2019/078897, which published Apr. 25, 2019, and was filed as International PCT Patent Application No. PCT/US2017/057739, filed Oct. 20, 2017, and is entitled BOROHYDRIDE-SULFIDE INTERFACIAL LAYER IN ALL SOLID STATE BATTERY.

In some embodiments, including any of the foregoing, the lithium salt is chosen from LiTFSI, LiFSI, LiPF₆, LiClO₄, LiAsF₆, LiBOB, LiBETI, LiBF₄, and LiI and combinations thereof. In certain examples, the lithium salt is selected from LiPF₆, Lithium bis(oxalato) borate (LiBOB), Lithium bis(perfluoroethanesulfonyl)imide (LIBETI), LiTFSi, LiBF₄, LiClO₄, LiAsF₆, LiFSI, or LiI. In certain examples, the lithium salt is LiPF₆. In certain examples, the lithium salt is LiBOB. In certain examples, the lithium salt is LiTFSi. In certain examples, the lithium salt is LiBF₄. In certain examples, the lithium salt is LiClO₄. In certain examples, the lithium salt is LiAsF₆. In certain examples, the lithium salt is LiI. In certain examples, the lithium salt is LiBF₄ In certain examples, several lithium salts may be present simultaneously in different concentrations. In some embodiments, the concentration is about 0.5, about 0.6, about 0.7, about 0.8, about 0.9, about 1.0, about 1.1, about 1.2, about 1.3, about 1.4, about 1.5, about 1.6, about 1.7, about 1.8, about 1.9 or about 2.0M. In certain examples, the bonding layer may contain two salts selected from LiPF₆, LiBOB, LiTFSi, LiBF₄, LiClO₄, LiAsF₆, LiFSI, or LiI. In certain examples, the bonding layer may contain three salts selected from LiPF₆, LiBOB, LiTFSi, LiBF₄, LiClO₄, LiAsF₆, LiFSI, or LiI. In certain examples, the lithium salt is a lithium salt is selected from LiPF₆, LiBOB, and LFTSi. In certain examples, the lithium salt is LiPF₆ at a concentration of 0.5 M to 2M. In some embodiments, the concentration is 0.5, 0.6, 0.7, 0.8, 0.9, 1.0, 1.1, 1.2, 1.3, 1.4, 1.5, 1.6, 1.7, 1.8, 1.9 or 2.0M. In certain examples, the lithium salt is LiTFSI at a concentration of 0.5 M to 2M. In some embodiments, the concentration is 0.5, 0.6, 0.7, 0.8, 0.9, 1.0, 1.1, 1.2, 1.3, 1.4, 1.5, 1.6, 1.7, 1.8, 1.9 or 2.0M.

In certain examples, the lithium salt is present at a concentration from 0.01 M to 10 M. In some embodiments, the concentration is 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.3, 3.2, 3.3, 3.4, 3.5, 3.6, 3.7, 3.8, 3.9, 2.0, 0.3, 0.2, 0.3, 0.4, 0.5, 0.6, 0.7, 0.8, 0.9, 3.0, 3.1, 3.2, 3.3, 3.4, 3.5, 3.6, 3.7, 3.8, 3.9, 4.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.8, 8.4, 8.5, 8.6, 8.7, 8.8, 8.9, 9.9, 9.1, 9.2, 9.3, 9.4, 9.5, 9.6, 9.7, 9.8, 9.9, 10.0 M.

In some embodiments, including any of the foregoing, the bonding layer comprises a lithium borohydride, a sodium borohydride, or a potassium borohydride. In some embodiments, including any of the foregoing, the lithium borohydride, sodium borohydride, or potassium borohydride is doped with LiNH₂. In some embodiments, including any of the foregoing, any one or more of the lithium borohydride, sodium borohydride, or potassium borohydride is doped with LiI. In some embodiments, including any of the foregoing, any one or more of the lithium borohydride, sodium borohydride, or potassium borohydride is doped with LiNH₂ and LiI.

In some embodiments, including any of the foregoing, the bonding layer comprises a borohydride composition comprising A(LiBH₄) (1-A) (P₂S₅), wherein 0.05≤A≤0.95. In some embodiments, 0.5<A<0.95. In some embodiments, A is 0.85, 0.9, or 9.95. In some embodiments, including any of the foregoing, the bonding layer comprises 0.9 (LiBH₄)0.1(P₂S₅).

In some embodiments, including any of the foregoing, the bonding layer is amorphous. In some embodiments, including any of the foregoing, the bonding layer is semi-crystalline. In some embodiments, including any of the foregoing, the bonding layer is polycrystalline.

### Electrolyte Separator

The electrolyte separator comprises a lithium-stuffed garnet.

In some embodiments, including any of the foregoing, the electrolyte separator is a bare film. In some embodiments, the bare film comprises a lithium-stuffed garnet.

In some embodiments, including any of the foregoing, the electrolyte separator is a co-sintered current collector film (i.e., CSC film). In some embodiments, the CSC film comprises a ceramic layer and a metal-ceramic layer. In some embodiments, the metal-ceramic layer of the CSC film comprises lithium-stuffed garnet. In some embodiments, the ceramic layer of the CSC film comprises lithium-stuffed garnet. In some embodiments, the metal-ceramic layer and the ceramic layer of the CSC film both comprise lithium-stuffed garnet.

In some embodiments, the metal-ceramic layer of the CSC film comprises a metal selected from the group consisting of nickel (Ni), iron (Fe), copper (Cu), platinum (Pt), gold (Au), silver (Ag), an alloy thereof, and a combination thereof. In some embodiments, the metal-ceramic layer comprises Ni. In some embodiments, the metal-ceramic layer comprises Fe. In some embodiments, the metal-ceramic layer comprises Ni at 0.0001-25 wt %, Fe at 1-25 wt %, or combinations thereof. In some embodiments, metal-ceramic layer comprises 1-20 wt % of Ni and 1-10 wt % of Fe, with the remainder being lithium-stuffed garnet. In some embodiments, the metal-ceramic layer comprises 5-15 wt % of Ni and 1-5 wt % of Fe, with the remainder being lithium-stuffed garnet. In some embodiments, the metal-ceramic layer comprises 10-15 wt % of Ni and 3-5 wt % of Fe, with the remainder being lithium-stuffed garnet.

In some embodiments, including any of the foregoing, the electrolyte separator is a bilayer. In some embodiments, the bilayer comprises a metal layer and a lithium-stuffed garnet layer.

In some embodiments, the metal layer of the bilayer comprises a metal selected from the group consisting of nickel (Ni), iron (Fe), copper (Cu), aluminum (Al), tin (Sn), indium (In), platinum (Pt), gold (Au), silver (Ag), steel, an alloy thereof, and a combination thereof. In some embodiments, the metal layer of the bilayer is a metal foil. In some embodiments, the metal layer of the bilayer comprises Ni. In some embodiments, the metal layer of the bilayer comprises Fe. In some embodiments, the metal layer of the bilayer comprises Ni and Fe. In some embodiments, the metal layer of the bilayer comprises an alloy.

In some embodiments, the metal layer of the bilayer is an alloy of Ni, consists essentially of Ni, or consists essentially of pure Ni, or consists only of pure Ni.

In some embodiments, the metal layer of the bilayer comprises a Ni alloy. In some embodiments, the metal layer of the bilayer comprises an alloy of Fe and Ni.

In some embodiments, the metal layer of the bilayer comprises an alloy of Fe and Ni, and the amount of Fe is about 1% to about 25% (w/w) with the remainder being Ni.

In some embodiments, the metal layer of the bilayer comprises an alloy of Fe and Ni, wherein the ratio of nickel to iron is 85:15.

In some embodiments, the metal layer of the bilayer comprises an alloy of Al and Ni, and the amount of Al is about 1% to about 25% (w/w) with the remainder being Ni.

In some embodiments, the separator comprises a lithium-stuffed garnet selected from LiₓLa_{y}Zr_{z}Oₜ·qAl₂O₃, wherein 4<x<10, 1<y<4, 1<z<3, 6<t<14, and 0≤q≤1.

In some embodiments, including any of the foregoing, the separator comprises a lithium-stuffed garnet selected from Li₇La₃Zr₂O₁₂·Al₂O₂O₃ and Li₇La₃Zr₂O₁₂·0.35Al₂O₃.

In some embodiments, including any of the foregoing, the lithium-stuffed garnet is doped with Nb, Ga, and/or Ta·₇La₃Zr₂O₁₂·Al₂O₃ and Li₇La₃Zr₂O₁₂·0.35Al₂O₃.

In some embodiments, including any of the foregoing, the separator comprises a lithium-stuffed garnet characterized by the formula LiₐLa_{b}Zr_{c}Al_{d}Me″ₑO_{f}, wherein 5<a<8.5; 2<b<4; 0≤c≤2.5; 0≤d<2; 0≤e<2, and 10<f<13 and Me″ is a metal selected from the group consisting of Nb, Ga, Ta, and combinations thereof.

In some embodiments, including any of the foregoing, the separator comprises a lithium-stuffed garnet oxide characterized by the formula LiᵤLaᵥZrₓO_{y}·zAl₂O₃, wherein u is a rational number from 4 to 8; v is a rational number from 2 to 4; x is a rational number from 1 to 3; y is a rational number from 10 to 14; and z is a rational number from 0.05 to 1; wherein u, v, x, y, and z are selected so that the lithium-stuffed garnet oxide is charge neutral.

In some embodiments, including any of the foregoing, the separator comprises a lithium-stuffed garnet oxide characterized by the formula LiᵤLaᵥZrₓO_{y}·zTa₂O₅, wherein u is a rational number from 4 to 10; v is a rational number from 2 to 4; x is a rational number from 1 to 3; y is a rational number from 10 to 14; and z is a rational number from 0 to 1; wherein u, v, x, y, and z are selected so that the lithium-stuffed garnet oxide is charge neutral.

In some embodiments, including any of the foregoing, the separator comprises a lithium-stuffed garnet oxide characterized by the formula LiᵤLaᵥZrₓO_{y}·zNb₂O₅, wherein u is a rational number from 4 to 10; v is a rational number from 2 to 4; x is a rational number from 1 to 3; y is a rational number from 10 to 14; and z is a rational number from 0 to 1; wherein u, v, x, y, and z are selected so that the lithium-stuffed garnet oxide is charge neutral.

In some embodiments, including any of the foregoing, the separator comprises a lithium-stuffed garnet oxide characterized by the formula LiᵤLaᵥZrₓO_{y}·zGa₂O₃, wherein u is a rational number from 4 to 10; v is a rational number from 2 to 4; x is a rational number from 1 to 3; y is a rational number from 10 to 14; and z is a rational number from 0 to 1; wherein u, v, x, y, and z are selected so that the lithium-stuffed garnet oxide is charge neutral.

In some embodiments, including any of the foregoing, the separator comprises a lithium-stuffed garnet oxide characterized by the formula LiᵤLaᵥZrₓO_{y}·zTa₂O₅·bAl₂O₃, wherein u is a rational number from 4 to 10; v is a rational number from 2 to 4; x is a rational number from 1 to 3; y is a rational number from 10 to 14; z is a rational number from 0 to 1; b is a rational number from 0 to 1; wherein z+b≤1; and u, v, x, y, and z are selected so that the lithium-stuffed garnet oxide is charge neutral.

In some embodiments, including any of the foregoing, the separator comprises a lithium-stuffed garnet oxide characterized by the formula LiᵤLaᵥZrₓO_{y}·zNb₂O₅·bAl₂O₃, wherein u is a rational number from 4 to 10; v is a rational number from 2 to 4; x is a rational number from 1 to 3; y is a rational number from 10 to 14; z is a rational number from 0 to 1; b is a rational number from 0 to 1; wherein z+b≤1; and u, v, x, y, and z are selected so that the lithium-stuffed garnet oxide is charge neutral.

In some embodiments, including any of the foregoing, the separator comprises a lithium-stuffed garnet oxide characterized by the formula LiᵤLaᵥZrₓO_{y}·zGa₂O₃·bAl₂O₃, wherein u is a rational number from 4 to 10; v is a rational number from 2 to 4; x is a rational number from 1 to 3; y is a rational number from 10 to 14; and is a rational number from 0 to 1; b is a rational number from 0 to 1; wherein z+b≤1; and u, v, x, y, and z are selected so that the lithium-stuffed garnet oxide is charge neutral.

In some embodiments, including any of the foregoing, the separator comprises a lithium-stuffed garnet characterized by the formula Li_{6.4}Ga_{0.2}La₃Zr₂O_{12.3}·bAl₂O₃, wherein u is a rational number from 4 to 10; v is a rational number from 2 to 4; x is a rational number from 1 to 3; y is a rational number from 10 to 14; and is a rational number from 0 to 1; b is a rational number from 0 to 1; wherein z+b≤1; and u, v, x, y, and z are selected so that the lithium-stuffed garnet oxide is charge neutral.

The separator may comprise any lithium-stuffed garnet set forth in U.S. Pat. No. 9,806,372 B2, which issued Oct. 31, 2017, and is titled Garnet MATERIALS FOR LI SECONDARY BATTERIES AND METHODS OF MAKING and USING GARNET MATERIALS, and U.S. Pat. No. 9,970,711, which issued May 15, 2018, and is titled LITHIUM STUFFED GARNET SETTER PLATES FOR SOLID ELECTROLYTE FABRICATION, the entire contents of which are herein incorporated by reference in their entirety for all purposes. The separator may be made by, for example, the methods in U.S. Pat. No. 9,806,372 B2. The separator may comprise any lithium-stuffed garnet set forth in U.S. Pat. No. 9,966,630, which issued May 8, 2018, and is titled ANNEALED GARNET ELECTROLYTE SEPARATORS, the entire contents of which are herein incorporated by reference in their entirety for all purposes. The separator may be made by, for example, the methods in U.S. Pat. No. 9,966,630 B2. The separator may comprise any lithium-stuffed garnet set forth in U.S. Pat. No. 10,347,937, which issued Jul. 9, 2019, and titled LITHIUM-STUFFED GARNET ELECTROLYTES WITH SECONDARY PHASE INCLUSIONS, the entire contents of which are herein incorporated by reference in their entirety for all purposes. The separator may be made by, for example, the methods in U.S. patent application Ser. No. 15/631,884. The separator may comprise any lithium-stuffed garnet set forth in set forth in International PCT Patent Application No. PCT/US2017/039069, filed Jun. 23, 2017, and titled LITHIUM-STUFFED GARNET ELECTROLYTES WITH SECONDARY PHASE INCLUSIONS, the entire contents of which are herein incorporated by reference in their entirety for all purposes. The separator may be made by, for example, the methods in PCT/US2017/039069, the entire contents of which are herein incorporated by reference in their entirety for all purposes. The separator may be made by, for example, the methods in WO/2022/192464, which published Sep. 15, 2022, and was filed as International PCT Patent Application No. PCT/US2022/19641, filed Mar. 9 2022, and entitled RAPID CERAMIC PROCESSING TECHNIQUES AND EQUIPMENT, the entire contents of which are herein incorporated by reference in their entirety for all purposes. The separator may be made by, for example, the methods in WO2023154571, which published Aug. 17, 2023, and was filed as International PCT Patent Application No. PCT/US2023/013048, filed Feb. 14, 2023, and entitled RAPID THERMAL PROCESSING METHODS AND APPARATUS, the entire contents of which are herein incorporated by reference in their entirety for all purposes. The separator may be made by, for example, the methods in WO/2024/059730, which published Mar. 21, 2024, and was filed as International PCT Patent Application No. PCT/US2023/074226, filed Sep. 14, 2023, and entitled PROCESSING APPARATUSES AND METHODS OF USING, the entire contents of which are herein incorporated by reference in their entirety for all purposes.

In some embodiments, the separator is chemically stable when in contact with Li metal. In some embodiments, the separator is kinetically stable when in contact with Li metal.

In some embodiments, the lithium-stuffed garnet comprises lithium lanthanum zirconium oxide (LLZO) and has good electrochemical stability and high mechanical strength, e.g. greater than 500 MPa. In some embodiments, the LLZO is suitable for use with a Li metal anode.

In some embodiments, the separator may be paired with a bonding agent set forth in WO2017197406A1, which published Nov. 16, 2017, and was filed as International PCT Patent Application No. PCT/US2017/032749, filed 15 May 2017, and entitled SOLID ELECTROLYTE SEPARATOR BONDING AGENT, the entire contents of which are herein incorporated by reference in their entirety for all purposes. In any embodiments herein, the lithium-stuffed garnet are made according to the methods in International PCT Patent Application No. PCT/US2016/027886, which was filed Apr. 15, 2016, and is titled LITHIUM STUFFED GARNET SETTER PLATES FOR SOLID ELECTROLYTE FABRICATION the entire contents of which are herein incorporated by reference in their entirety for all purposes. In any embodiments herein, the lithium-stuffed garnet are made according to the methods in International PCT Patent Application No. PCT/US2016/027922, which was filed Apr. 15, 2016, and is titled SETTER PLATES FOR SOLID ELECTROLYTE FABRICATION AND METHODS OF USING THE SAME TO PREPARE DENSE SOLID ELECTROLYTES, the entire contents of which are herein incorporated by reference in their entirety for all purposes. In any examples herein, the lithium-stuffed garnet are made according to the methods in International PCT Patent Application No. PCT/US2016/043428, which was filed Jul. 21, 2016, and is titled PROCESSES AND MATERIALS FOR CASTING AND SINTERING GREEN GARNET THIN FILMS, the entire contents of which are herein incorporated by reference in their entirety for all purposes. In any embodiments herein, the lithium-stuffed garnet are made according to the methods in U.S. Pat. No. 9,970,711, which issued May 15, 2018, and is titled LITHIUM STUFFED GARNET SETTER PLATES FOR SOLID ELECTROLYTE FABRICATION, the entire contents of which are herein incorporated by reference in their entirety for all purposes. In any embodiments herein, the lithium-stuffed garnet are made according to the methods in U.S. Pat. No. 9,970,711, which issued May 15, 2018, and is titled LITHIUM STUFFED GARNET SETTER PLATES FOR SOLID ELECTROLYTE FABRICATION, the entire contents of which are herein incorporated by reference in their entirety for all purposes. The sulfide in the sulfide catholyte in some embodiments may be any sulfide set forth in U.S. Pat. No. 9,172,114, which issued Oct. 27, 2015, and is titled SOLID STATE CATHOLYTES AND ELECTROLYTES FOR ENERGY STORAGE DEVICES, the entire contents of which are herein incorporated by reference in their entirety for all purposes. The sulfide in the sulfide catholyte in some embodiments may be any sulfide set forth in International PCT Patent Application No. PCT/US2016/015982, filed Feb. 1, 2016, and titled METAL SULFIDE ANOLYTE FOR ELECTROCHEMICAL CELLS, and which published as WO 2016/126610 on Aug. 11, 2016, the entire contents of which are herein incorporated by reference in their entirety for all purposes. The sulfide in the sulfide catholyte In some embodiments may be any sulfide set forth in International PCT Patent Application No. PCT/US2016/039424, filed Jun. 24, 2016, and titled COMPOSITE ELECTROLYTES, and which published as WO 2016/210371, on Dec. 29, 2016, the entire contents of which are herein incorporated by reference in their entirety for all purposes. The sulfide in the sulfide catholyte in some embodiments may be any sulfide set forth in US Patent Application Publication No. 2017-0005367 A1, entitled COMPOSITE ELECTROLYTES, which published Jan. 5, 2017, the entire contents of which are herein incorporated by reference in their entirety for all purposes. The sulfide in the sulfide catholyte In some embodiments may be any sulfide set forth in International PCT Patent Application NO. PCT/US2016/064492, filed Dec. 1, 2016, and entitled LITHIUM, PHOSPHORUS, SULFUR, AND IODINE CONTAINING ELECTROLYTE AND CATHOLYTE COMPOSITIONS, ELECTROLYTE MEMBRANES FOR ELECTROCHEMICAL DEVICES, AND ANNEALING METHODS OF MAKING THESE ELECTROLYTES AND CATHOLYTES, and which published as WO 2017/096088 on Jun. 8, 2017, the entire contents of which are herein incorporated by reference in their entirety for all purposes.

The sulfide in the buffer layer in some embodiments may be any sulfide set forth in U.S. Pat. No. 9,172,114, which issued Oct. 27, 2015, and is titled SOLID STATE CATHOLYTES AND ELECTROLYTES FOR ENERGY STORAGE DEVICES, the entire contents of which are herein incorporated by reference in their entirety for all purposes. The sulfide in the buffer layer In some embodiments may be any sulfide set forth in International PCT Patent Application No. PCT/US2016/015982, filed Feb. 1, 2016, and titled METAL SULFIDE ANOLYTE FOR ELECTROCHEMICAL CELLS, and which published as WO 2016/126610 on Aug. 11, 2016, the entire contents of which are herein incorporated by reference in their entirety for all purposes. The sulfide in the buffer layer in some embodiments may be any sulfide set forth in International PCT Patent Application No. PCT/US2016/039424, filed Jun. 24, 2016, and titled COMPOSITE ELECTROLYTES, and which published as WO 2016/210371, on Dec. 29, 2016, the entire contents of which are herein incorporated by reference in their entirety for all purposes.

In some embodiments, a positive electrode includes about 85 wt % LLZO coated NCA, about 13 wt % LSTPS and about 2 wt % binder.

In some embodiments, a positive electrode includes about 87 wt % LZO coated NMC, about 12 wt % LPSCl and about 1 wt % binder.

In some embodiments, a positive electrode includes about 86 wt % LZO coated NMC, about 13 wt % LPSCl and about 1 wt % binder.

In some embodiments, a positive electrode includes about 88 wt % LZO coated NMC, about 11 wt % LPSCl and about 1 wt % binder.

In some embodiments, including any of the foregoing, the negative electrode is a lithium (Li) metal electrode layer. In some embodiments, including any of the foregoing, the at least one current collector includes a material selected from the group consisting of carbon (C)-coated nickel (Ni), nickel (Ni), copper (Cu), aluminum (Al), and stainless steel. In some embodiments, including any of the foregoing, the negative electrode current collector includes a material selected from the group consisting of carbon (C)-coated nickel (Ni), nickel (Ni), and copper (Cu). In some embodiments, including any of the foregoing, the positive electrode current collector layer includes a material selected from the group consisting of carbon (C)-coated aluminum and aluminum. In some embodiments, including any of the foregoing, the negative electrode current collector layer is C-coated Ni. In some embodiments, including any of the foregoing, the positive electrode current collector layer is C-coated Al.

### Buffer Layer Dimensions

In some embodiments, including any of the foregoing, the thickness of the buffer layer is from about 1 μm to about 50 μm. In some embodiments, including any of the foregoing, the thickness of the buffer layer is about 1 μm to about 25 μm. In some embodiments, including any of the foregoing, the thickness of the buffer layer is about 1 μm to about 15 μm. In some embodiments, including any of the foregoing, the thickness of the buffer layer is about 5 μm to about 15 μm.

In some embodiments, the thickness of the buffer layer is about 1 μm. In some embodiments, the thickness of the buffer layer is about 2 μm. In some embodiments, the thickness of the buffer layer is about 3 μm. In some embodiments, the thickness of the buffer layer is about 4 μm. In some embodiments, the thickness of the buffer layer is about 5 μm. In some embodiments, the thickness of the buffer layer is about 6 μm. In some embodiments, the thickness of the buffer layer is about 7 μm. In some embodiments, the thickness of the buffer layer is about 8 μm. In some embodiments, the thickness of the buffer layer is about 9 μm. In some embodiments, the thickness of the buffer layer is about 10 μm.

In some embodiments, the thickness of the buffer layer is 1 μm. In some embodiments, the thickness of the buffer layer is 2 μm. In some embodiments, the thickness of the buffer layer is 3 μm. In some embodiments, the thickness of the buffer layer is 4 μm. In some embodiments, the thickness of the buffer layer is 5 μm. In some embodiments, the thickness of the buffer layer is 6 μm. In some embodiments, the thickness of the buffer layer is 7 μm. In some embodiments, the thickness of the buffer layer is 8 μm. In some embodiments, the thickness of the buffer layer is 9 μm. In some embodiments, the thickness of the buffer layer is 10 μm.

In some embodiments, including any of the foregoing, the single ion conducting, solid-state buffer is mixed within the positive electrode layer to a depth of penetration within the positive electrode layer from about 1 μm to about 50 μm. This depth of penetration is measured from the edge where the positive electrode layer interfaces with either the buffer layer or the borohydride bonding layer. In some embodiments, if the positive electrode layer is 200 μm thick, and the depth of penetration within the positive electrode layer from about 1 μm to about 50 μm, this means that the buffer is present in the positive electrode on the side closest to the buffer layer, if present, or borohydride bonding layer, if no buffer layer present. In some embodiments, if the positive electrode layer is 200 μm thick, and the depth of penetration within the positive electrode layer from about 1 μm to about 50 μm, this also means that the side of the positive electrode which is contact with the positive current collector has no buffer component.

In some embodiments, including any of the foregoing, the single ion conducting, solid-state buffer is mixed within the positive electrode layer to a depth of penetration within the positive electrode layer from about 1 μm to about 50 μm. This depth of penetration is measured from the edge where the positive electrode layer interfaces with either the buffer layer or the borohydride bonding layer. In some embodiments, if the positive electrode layer is 150 μm thick, and the depth of penetration within the positive electrode layer from about 1 μm to about 50 μm, this means that the buffer is present in the positive electrode on the side closest to the buffer layer, if present, or borohydride bonding layer, if no buffer layer present. In some embodiments, if the positive electrode layer is 150 μm thick, and the depth of penetration within the positive electrode layer from about 1 μm to about 50 μm, this also means that the side of the positive electrode which is contact with the positive current collector has no buffer component.

In some embodiments, including any of the foregoing, the buffer layer is between and in direct contact with the positive electrode layer and the separator layer. In some embodiments, the buffer layer has a thickness ranging from about 1 μm to about 15 μm. In some embodiments, the buffer layer has a thickness of 1 μm. In some embodiments, the buffer layer has a thickness of 1 μm. In some instances, the buffer layer has a thickness of 2 μm. In some embodiments, the buffer layer has a thickness of 3 μm. In some embodiments, the buffer layer has a thickness of 4 μm. In some embodiments, the buffer layer has a thickness of 5 μm. In some instances, the buffer layer has a thickness of 6 μm. In some embodiments, the buffer layer has a thickness of 7 μm. In some instances, the buffer layer has a thickness of 8 μm. In some embodiments, the buffer layer has a thickness of 9 μm. In some instances, the buffer layer has a thickness of 10 μm. In some embodiments, the buffer layer has a thickness of 11 μm. In some embodiments, the buffer layer has a thickness of 12 μm. In some instances, the buffer layer has a thickness of 13 μm. In some embodiments, the buffer layer has a thickness of 14 μm. In some embodiments, the buffer layer has a thickness of 15 μm.

### Bonding Layer Dimensions

In some embodiments, the bonding layer comprises a lithium borohydride. In some embodiments, the bonding layer comprises lithium borohydride particles that are at least about 1 μm in average diameter. In some embodiments, the bonding layer comprises lithium borohydride particles that are about 0.01 μm to about 1000 μm. In some embodiments, the bonding layer comprises lithium borohydride particles that are about 0.01 μm to about 500 μm. In some embodiments, the bonding layer comprises lithium borohydride particles that are about 0.01 μm to about 200 μm. In some embodiments, the bonding layer comprises lithium borohydride particles that are about 0.01 μm to about 150 μm. In some embodiments, the bonding layer comprises lithium borohydride particles that are about 0.01 μm to about 100 μm. In some embodiments, the bonding layer comprises lithium borohydride particles that are about 0.01 μm to about 50 μm. In some embodiments, the bonding layer comprises lithium borohydride particles that are about 0.01 μm to about 25 μm. In some embodiments, the bonding layer comprises lithium borohydride particles that are about 0.01 μm to about 20 μm. In some embodiments, the bonding layer comprises lithium borohydride particles that are about 1 μm to about 50 μm, about 2 μm to about 20 μm, or about 1 μm to about 10 μm in average diameter.

In some embodiments, the bonding layer comprises lithium borohydride particles having a D₉₀ particle size about 0.01 μm to about 200 μm. In some embodiments, the bonding layer comprises lithium borohydride particles having a D₉₀ particle size about 0.01 μm to about 150 μm. In some embodiments, the bonding layer comprises lithium borohydride particles having a D₉₀ particle size about 0.01 μm to about 100 μm. In some embodiments, the bonding layer comprises lithium borohydride particles having a D₉₀ particle size about 0.01 μm to about 50 μm. In some embodiments, the bonding layer comprises lithium borohydride particles having a D₉₀ particle size about 0.01 μm to about 25 μm. In some embodiments, the bonding layer comprises lithium borohydride particles having a D₉₀ particle size about 0.01 μm to about 20 μm.

In some embodiments, the bonding layer comprises lithium borohydride particles having a D₅₀ particle size about 0.01 μm to about 100 μm. In some embodiments, the bonding layer comprises lithium borohydride particles having a D₅₀ particle size about 0.01 μm to about 50 μm. In some embodiments, the bonding layer comprises lithium borohydride particles having a D₅₀ particle size about 0.01 μm to about 25 μm. In some embodiments, the bonding layer comprises lithium borohydride particles having a D₅₀ particle size about 0.01 μm to about 20 μm. In some embodiments, the bonding layer comprises lithium borohydride particles having a D₅₀ particle size about 1 μm to about 20 μm. In some embodiments, the bonding layer comprises lithium borohydride particles having a D₅₀ particle size about 1 μm to about 15 μm. In some embodiments, the bonding layer comprises lithium borohydride particles having a D₅₀ particle size about 5 μm to about 15 μm.

In some embodiments, prior to assembly of the battery cell, the bonding layer comprises particles that are at least about 1 μm in average diameter. In some embodiments, the bonding layer particles are about 0.01 μm to about 1000 μm, 0.01 μm to about 500 μm, 0.01 μm to about 200 μm, about 0.01 μm to about 150 μm, 0.01 μm to about 100 μm, 0.01 μm to about 50 μm, 0.01 μm to about 25 μm, or about about 0.01 μm to about 20 μm. In some embodiments, the bonding layer particles that are about 1 μm to about 50 μm, about 2 μm to about 20 μm, or about 1 μm to about 10 μm in average diameter. In some embodiments the bonding layer particles have a D₉₀ particle size of about 0.01 μm to about 200 μm, 0.01 μm to about 150 μm, 0.01 μm to about 100 μm, 0.01 μm to about 50 μm, 0.01 μm to about 25 μm, or 0.01 μm to about 20 μm. the bonding layer particles have a D₅₀ particle size about 0.01 μm to about 100 μm, 0.01 μm to about 50 μm, 0.01 μm to about 25 μm, 0.01 μm to about 20 μm, 1 μm to about 20 μm, 1 μm to about 15 μm, or about 5 μm to about 15 μm.

In some embodiments, including any of the foregoing, the thickness of the bonding layer is from about 0.01 μm to about 50 μm. In some embodiments, including any of the foregoing, the thickness of the bonding layer is from about 1 μm to about 50 μm. In some embodiments, including any of the foregoing, the thickness of the bonding layer is from about 1 μm to about 45 μm. In some embodiments, including any of the foregoing, the thickness of the bonding layer is from about 1 μm to about 45 μm. In some embodiments, including any of the foregoing, the thickness of the bonding layer is from about 1 μm to about 30 μm. In some embodiments, including any of the foregoing, the thickness of the bonding layer is from about 1 μm to about 20 μm. In some embodiments, including any of the foregoing, the thickness of the bonding layer is from about 1 μm to about 15 μm. In some embodiments, including any of the foregoing, the thickness of the bonding layer is from about 1 μm to about 10 μm. In some embodiments, including any of the foregoing, the thickness of the bonding layer is from about 1 μm to about 5 μm. In some embodiments, including any of the foregoing, the thickness of the bonding layer is from about 0.01 μm to about 5 μm.

In some embodiments, the thickness of the bonding layer is 1 μm. In some embodiments, the thickness of the bonding layer is 2 μm. In some embodiments, the thickness of the bonding layer is 3 μm. In some embodiments, the thickness of the bonding layer is 4 μm. In some embodiments, the thickness of the bonding layer is 5 μm. In some embodiments, the thickness of the bonding layer is 6 μm. In some embodiments, the thickness of the bonding layer is 7 μm. In some embodiments, the thickness of the bonding layer is 8 μm. In some embodiments, the thickness of the bonding layer is 9 μm. In some embodiments, the thickness of the bonding layer is 10 μm. In some embodiments, the thickness of the bonding layer is 11 μm. In some embodiments, the thickness of the bonding layer is 12 μm. In some embodiments, the thickness of the bonding layer is 13 μm. In some embodiments, the thickness of the bonding layer is 14 μm. In some embodiments, the thickness of the bonding layer is 15 μm. In some embodiments, the thickness of the bonding layer is 16 μm. In some embodiments, the thickness of the bonding layer is 17 μm. In some embodiments, the thickness of the bonding layer is 18 μm. In some embodiments, the thickness of the bonding layer is 19 μm. In some embodiments, the thickness of the bonding layer is 20 μm. In some embodiments, the thickness of the bonding layer is 31 μm. In some embodiments, the thickness of the bonding layer is 32 μm. In some embodiments, the thickness of the bonding layer is 33 μm. In some embodiments, the thickness of the bonding layer is 34 μm. In some embodiments, the thickness of the bonding layer is 35 μm. In some embodiments, the thickness of the bonding layer is 36 μm. In some embodiments, the thickness of the bonding layer is 37 μm. In some embodiments, the thickness of the bonding layer is 38 μm. In some embodiments, the thickness of the bonding layer is 39 μm. In some embodiments, the thickness of the bonding layer is 40 μm. In some embodiments, the thickness of the bonding layer is 41 μm. In some embodiments, the thickness of the bonding layer is 42 μm. In some embodiments, the thickness of the bonding layer is 43 μm. In some embodiments, the thickness of the bonding layer is 44 μm. In some embodiments, the thickness of the bonding layer is 45 μm. In some embodiments, the thickness of the bonding layer is 46 μm. In some embodiments, the thickness of the bonding layer is 47 μm. In some embodiments, the thickness of the bonding layer is 48 μm. In some embodiments, the thickness of the bonding layer is 49 μm. In some embodiments, the thickness of the bonding layer is 50 μm.

In some embodiments, the thickness of the bonding layer is measured by 3D optical profilometry. In some embodiments, the thickness of the bonding layer is a maximum thickness.

In some embodiments, including any of the foregoing, the bonding layer penetrates into the buffer layer.

In some embodiments, including any of the foregoing, the bonding layer penetrates into the separator. In some embodiments, including any of the foregoing, the bonding layer penetrates into the lithium-stuffed garnet layer of the separator.

In some embodiments, including any of the foregoing, the bonding layer penetrates into the buffer layer and the separator.

In some embodiments, including any of the foregoing, the bonding layer has a density of 90% or above of the raw material density as measured by quantitative analysis of a cross-section SEM image. Density is determined by analyzing porosity as a function of total area using an SEM image and analytical software.

In some embodiments, including any of the foregoing, the bonding layer has a density of 90% or above of the raw material density as measured by quantitative analysis of a cross-section SEM image.

In some embodiments, including any of the foregoing, the bonding layer has a melting point below 250° C. In some embodiments, including any of the foregoing, the bonding layer has a melting point above 250° C.

In some embodiments, the bonding layer has a melting point of about 115° C. to about 130° C., about 120° C. to about 130° C., 125° C. to about 130° C., 115° C. to about 125° C., 115° C. to about 120° C., or about 120° C. to about 125° C.

In some embodiments, including any of the foregoing, the SSEC further comprises a negative electrode.

In some embodiments, including any of the foregoing, the negative electrode is a lithium (Li) metal negative electrode.

In some embodiments, including any of the foregoing, the separator contacts the negative electrode.

In certain embodiments, the composition may be a thin film and include a porosity as determined by SEM for the thin film. For example, in one embodiment, the compositions set forth herein may have a porosity less than 5%. By way of further example, in one embodiment, the compositions set forth herein may have a porosity less than 6%. By way of further example, in one embodiment, the compositions set forth herein may have a porosity less than 7%. By way of further example, in one embodiment, the compositions set forth herein may have a porosity less than 8%. By way of further example, in one embodiment, the compositions set forth herein may have a porosity less than 4%. By way of further example, in one embodiment, the compositions set forth herein may have a porosity less than 3%. By way of further example, in one embodiment, the compositions set forth herein may have a porosity less than 2%. By way of further example, in one embodiment, the compositions set forth herein may have a porosity less than 1%. By way of further example, in one embodiment, the compositions set forth herein may have a porosity less than 0.5%.

In some embodiments, the solid-state electrochemical stack described above further includes a bonding layer between and in direct contact with the buffer layer and the separator layer.

In some embodiments, set forth herein is a bonding layer having a thickness of about 1 nm. In some embodiments, set forth herein is a bonding layer having a thickness of about 5 nm to about 100 nm.

In some embodiments, set forth herein is a bonding layer having a thickness of about 100 nm to about 1000 nm. In some embodiments, the bonding layer has a thickness of about 200 nm to about 900 nm, about 300 nm to about 800 nm, or about 500 nm.

In some embodiments, set forth herein is a bonding layer having a thickness of about 1 μm. In some embodiments, set forth herein is a bonding layer having a thickness of about 2 μm. In some embodiments, set forth herein is a bonding layer having a thickness of about 3 μm. In some embodiments, set forth herein is a bonding layer having a thickness of about 4 μm. In some embodiments, set forth herein is a bonding layer having a thickness of about 5 μm to about 100 μm. In some embodiments, set forth herein is a bonding layer having a thickness of about 10 μm to about 50 μm, about 15 μm to about 40 μm, or 20 μm to about 40 μm. In some embodiments, set forth herein is a bonding layer having a thickness of about 1 μm. In some embodiments, set forth herein is a bonding layer having a thickness of about 2 μm. In some embodiments, set forth herein is a bonding layer having a thickness of about 3 μm. In some embodiments, set forth herein is a bonding layer having a thickness of about 4 μm. In some embodiments, set forth herein is a bonding layer having a thickness of about 5 μm. In some embodiments, set forth herein is a bonding layer having a thickness of about 100 μm. In some embodiments, set forth herein is a bonding layer having a thickness of about 1 μm to about 100 μm, of about 1 μm to about 50 μm, or of about 5 μm to about 50 μm.

In some embodiments, including any of the foregoing, the bonding layer is greater than 100 nm and less than 10 μm in median thickness. In some embodiments, including any of the foregoing, the polymer has a crosslink density greater than 0.1% and less than 30% as measured by ASTM D2765. In some embodiments, including any of the foregoing, the bonding layer lowers the interfacial impedance between the electrolyte separator and the positive electrode than it otherwise would be in the absence of the bonding layer. In some embodiments, the bonding layer lowers the interfacial impedance between the electrolyte separator and the positive electrode than it otherwise would be in the absence of the bonding layer. In some embodiments, the interfacial impedance between the oxide electrolyte separator and the positive electrode is less than 50 Ω·cm² at 50° C., when the bonding layer is positioned between and in direct contact with the oxide electrolyte separator and the positive electrode. In some embodiments, the interfacial impedance between the oxide electrolyte separator and the positive electrode is less than 25 Ω·cm² at 50° C. In some embodiments, the interfacial impedance between the oxide electrolyte separator and the positive electrode is less than 10 Ω·cm² at 50° C. In some embodiments, the interfacial impedance between the oxide electrolyte separator and the positive electrode is less than 5 Ω·cm² at 50° C. In some embodiments, the interfacial impedance between the oxide electrolyte separator and the positive electrode is less than 5 Ω·cm² at 30° C. In some embodiments, the interfacial impedance between the oxide electrolyte separator and the positive electrode is less than 5 Ω·cm² at 20° C. In some embodiments, the interfacial impedance between the oxide electrolyte separator and the positive electrode is less than 5 Ω·cm² at 10° C. In some embodiments, the interfacial impedance between the oxide electrolyte separator and the positive electrode is less than 5 Ω·cm² at 0° C. In some embodiments, including any of the foregoing, the interfacial impedance between the electrolyte separator and the positive electrode is less than 50 Ω·cm² at 50° C. In some embodiments, including any of the foregoing, the interfacial impedance between the electrolyte separator and the positive electrode is less than 25 Ω·cm² at 50° C. In some embodiments, including any of the foregoing, the interfacial impedance between the electrolyte separator and the positive electrode is less than 10 Ω·cm² at 50° C. In some embodiments, including any of the foregoing, the interfacial impedance between the electrolyte separator and the positive electrode is less than 5 Ω·cm² at 50° C. In some embodiments, including any of the foregoing, the positive electrode includes a lithium intercalation material, a lithium conversion material, or a combination thereof.

In some embodiments, the bonding layer penetrates into the positive electrode. In other examples, bonding layer penetrates into the positive electrode at least 10% of the thickness of the positive electrode. In other examples, bonding layer penetrates into the positive electrode at least 9% of the thickness of the positive electrode. In other examples, bonding layer penetrates into the positive electrode at least 8% of the thickness of the positive electrode. In other examples, bonding layer penetrates into the positive electrode at least 7% of the thickness of the positive electrode. In other examples, bonding layer penetrates into the positive electrode at least 6% of the thickness of the positive electrode. In other examples, bonding layer penetrates into the positive electrode at least 5% of the thickness of the positive electrode. In other examples, bonding layer penetrates into the positive electrode at least 4% of the thickness of the positive electrode. In other examples, bonding layer penetrates into the positive electrode at least 3% of the thickness of the positive electrode. In other examples, bonding layer penetrates into the positive electrode at least % of the thickness of the positive electrode. In other examples, bonding layer penetrates into the positive electrode at least 1% of the thickness of the positive electrode.

In some embodiments, the bonding layer contacts the catholyte in the positive electrode. In some embodiments, the bonding layer does not creep around the electrolyte separator. In some embodiments, the bonding layer does not include components which volatilize and diffuse around the electrolyte separator to contact the Li metal negative electrode.

In some embodiments, including any of the foregoing, the bonding layer penetrates into the positive electrode at least 10% of the thickness of the positive electrode.

In some embodiments, including any of the foregoing, the bonding layer contacts the solid state catholyte in the positive electrode.

In some embodiments, including any of the foregoing, the diameter of the electrolyte separator is greater than the diameter of the positive electrode.

In some embodiments, including any of the foregoing, the width or diameter of the electrolyte separator is greater than the width or diameter, respectively, of the positive electrode.

In some embodiments, including any of the foregoing, the width of the separator is greater than the width of the positive electrode and the length of the separator is greater than the length of the positive electrode.

In some embodiments, including any of the foregoing, the electrolyte separator has raised edges, which protect the bonding layer, or its constituent components, from creeping around the electrolyte separator.

In some embodiments, including any of the foregoing, the coated edges include a coating selected from parylene, polypropylene, polyethylene, alumina, Al₂O₃, ZrO₂, TiO₂, SiO₂, a binary oxide, La₂Zr₂O₇, a lithium carbonate species, or a glass, wherein the glass is selected from SiO₂—B₂O₃, or Al₂O₃.

In some embodiments, the bonding layer includes LBHI, LBHIN, [LBH-X], LBHPS, LiI, LPS, L[X]PS, or Li₃PO₄. In some embodiments, the borohydride bonding layer includes functionalized polymer, such as PEO-LiTFSI, poly-propylene carbonate (PPC)-LiTFSI, poly-ethylene carbonate (PEC)-LiTFSI, Li-poly(2-acrylamido-2-methyl-1-propane sulphonic acid) (PAMPS), Li-Nafion, Li-polyphenylene sulfide (PPS); or solid organic salt pair, such as ethylene carbonate (EC)-LiTFSI, Dimethyl sulfide (DMS)-LiPF₆, and succinonitrile (SCN)-LiBF₄.

### Other Component Dimensions

In some embodiments, including any of the foregoing, the thickness of the positive electrode layer is from about 100 μm to about 1000 μm. In some embodiments, including any of the foregoing, the thickness of the positive electrode layer is from about 100 μm to about 200 μm. In some embodiments, including any of the foregoing, the thickness of the positive electrode layer is from about 100 μm to about 175 μm. In some embodiments, the thickness of the positive electrode layer is about 10 μm. In some embodiments, the thickness of the positive electrode layer is about 20 μm. In some embodiments, the thickness of the positive electrode layer is about 30 μm. In some embodiments, the thickness of the positive electrode layer is about 40 μm. In some embodiments, the thickness of the positive electrode layer is about 50 μm. In some embodiments, the thickness of the positive electrode layer is about 60 μm. In some embodiments, the thickness of the positive electrode layer is about 70 μm. In some embodiments, the thickness of the positive electrode layer is about 80 μm. In some embodiments, the thickness of the positive electrode layer is about 90 μm. In some embodiments, the thickness of the positive electrode layer is about 100 μm. In some embodiments, the thickness of the positive electrode layer is about 110 μm. In some embodiments, the thickness of the positive electrode layer is about 120 μm. In some embodiments, the thickness of the positive electrode layer is about 130 μm. In some embodiments, the thickness of the positive electrode layer is about 140 μm. In some embodiments, the thickness of the positive electrode layer is about 150 μm. In some embodiments, the thickness of the positive electrode layer is about 160 μm. In some embodiments, the thickness of the positive electrode layer is about 170 μm. In some embodiments, the thickness of the positive electrode layer is about 180 μm. In some embodiments, the thickness of the positive electrode layer is about 190 μm. In some embodiments, the thickness of the positive electrode layer is about 200 μm.

In some embodiments, including any of the foregoing, the thickness of the separator is from about 1 μm to about 200 μm. In some embodiments, the thickness of the separator is 10 μm. In some embodiments, the thickness of the separator is 20 μm. In some embodiments, the thickness of the separator is 30 μm. In some embodiments, the thickness of the separator is 40 μm. In some embodiments, the thickness of the separator is 50 μm. In some embodiments, the thickness of the separator is 60 μm. In some embodiments, the thickness of the separator is 70 μm. In some embodiments, the thickness of the separator is 80 μm. In some embodiments, the thickness of the separator is 90 μm. In some embodiments, the thickness of the separator is 100 μm. In some embodiments, the thickness of the separator is 110 μm. In some embodiments, the thickness of the separator is 120 μm. In some embodiments, the thickness of the separator is 130 μm. In some embodiments, the thickness of the separator is 140 μm. In some embodiments, the thickness of the separator is 150 μm. In some embodiments, the thickness of the separator is 160 μm. In some embodiments, the thickness of the separator is 170 μm. In some embodiments, the thickness of the separator is 180 μm. In some embodiments, the thickness of the separator is 190 μm. In some embodiments, the thickness of the separator is 200 μm.

In some embodiments, the separator is a bare film and the thickness of the bare film is about 1 μm to about 200 μm, about 1 μm to about 175 μm, about 1 μm to about 150 μm, about 1 μm to about 100 μm, about 1 μm to about 75 μm, about 1 μm to about 50 μm, or about 1 μm to about 30 μm.

In some embodiments, the separator is a CSC film comprising a metal-ceramic layer and a ceramic layer and the overall thickness of the CSC film is 1 μm to about 200 μm, about 1 μm to about 175 μm, about 1 μm to about 150 μm, about 1 μm to about 100 μm, about 1 μm to about 75 μm, about 1 μm to about 50 μm, or about 1 μm to about 30 μm.

In some embodiments, the separator is a CSC film comprising a metal-ceramic layer and a ceramic layer, and the thickness of the metal-ceramic layer is about 0.01 μm to about 20 μm, about 1 μm to about 20 μm, about 1 μm to about 15 μm, about 1 μm to about 10 μm, about 5 μm to about 10 μm, or about 5 μm to about 15 μm. In some embodiments, the metal-ceramic layer of the CSC film has a thickness of about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, or about 20 μm thick. In some embodiments, the metal-ceramic layer of the CSC film comprises lithium-stuffed garnet. In some embodiments, the ceramic layer of the CSC film comprises lithium-stuffed garnet. In some embodiments, the metal-ceramic layer and the ceramic layer of the CSC film both comprise lithium-stuffed garnet.

In some embodiments, the separator is a CSC film comprising a metal-ceramic layer and a ceramic layer and the thickness of the ceramic layer is about 1 μm to about 100 μm, about 1 μm to about 75 μm, or about 1 μm to about 50 μm. In some embodiments, the metal-ceramic layer of the CSC film has a thickness of about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, or about 50 μm thick.

In some embodiments, the separator is a bilayer comprising a lithium-stuffed garnet layer and a metal layer and the thickness of the metal layer is about 0.01 μm to about 20 μm, about 1 μm to about 20 μm, about 1 μm to about 15 μm, about 1 μm to about 10 μm, about 5 μm to about 10 μm, or about 5 μm to about 15 μm. In some embodiments, the metal layer of the bilayer has a thickness of about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, or about 20 μm thick.

In some embodiments, the separator is a bilayer comprising a lithium-stuffed garnet layer and a metal layer and the thickness of the lithium-stuffed garnet layer is about 1 μm to about 100 μm, about 1 μm to about 75 μm, or about 1 μm to about 50 μm. In some embodiments, the lithium-stuffed garnet layer of the bilayer has a thickness of about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, or about 50 μm thick.

In some embodiments, including any of the foregoing, the separator layer in a solid-state electrochemical stack described herein is rectangular shaped. In another embodiment, the positive electrode layer in a solid-state electrochemical stack described herein is rectangular shaped. In a different embodiment, the separator layer in a solid-state electrochemical stack described herein is circular shaped. In an embodiment, the positive electrode layer in a solid-state electrochemical stack described herein is circular shaped.

In some embodiments, including any of the foregoing, the geometric surface area of the positive electrode layer and the geometric surface area separator layer are substantially the same.

In some embodiments, including any of the foregoing, the geometric surface area of the positive electrode layer is less than the geometric surface area of the separator.

In some embodiments, including any of the foregoing, one edge of the positive electrode layer is 2 cm to 30 cm in length. In some embodiments, one edge of the positive electrode layer is 2 cm, 3, cm, 4 cm, 5 cm, 6 cm, 7 cm, 8 cm, 9 cm, 10 cm, 11 cm, 12 cm, 13 cm, 14 cm, 15 cm, 16 cm, 17 cm, 18 cm, 19 cm, 20 cm, 21 cm, 22 cm, 23 cm, 24 cm, 25 cm, 26 cm, 27 cm, 28 cm, 29 cm, or 30 cm in length. In some embodiments, one edge of the separator layer is 2 cm to 30 cm in length. In some embodiments, one edge of the separator layer is 2 cm, 3, cm, 4 cm, 5 cm, 6 cm, 7 cm, 8 cm, 9 cm, 10 cm, 11 cm, 12 cm, 13 cm, 14 cm, 15 cm, 16 cm, 17 cm, 18 cm, 19 cm, 20 cm, 21 cm, 22 cm, 23 cm, 24 cm, 25 cm, 26 cm, 27 cm, 28 cm, 29 cm, or 30 cm in length.

In some embodiments, including any of the foregoing, one edge of the positive electrode layer is 40 cm to 75 cm in length. In some embodiments, one edge of the positive electrode layer is 40 cm, 41 cm, 42 cm, 43 cm, 44 cm, 45 cm, 46 cm, 47 cm, 48 cm, 49 cm, 50 cm, 51 cm, 52 cm, 53 cm, 54 cm, 55 cm, 56 cm, 57 cm, 58 cm, 59 cm, 60 cm, 61 cm, 62 cm, 63 cm, 64 cm, 65 cm, 66 cm, 67 cm, 68 cm, 69 cm, 70 cm, 71 cm, 72 cm, 73 cm, 74 cm, or 75 cm in length. In some embodiments, including any of the foregoing, one edge of the separator is 40 cm to 75 cm in length. In some embodiments, one edge of the separator is 40 cm, 41 cm, 42 cm, 43 cm, 44 cm, 45 cm, 46 cm, 47 cm, 48 cm, 49 cm, 50 cm, 51 cm, 52 cm, 53 cm, 54 cm, 55 cm, 56 cm, 57 cm, 58 cm, 59 cm, 60 cm, 61 cm, 62 cm, 63 cm, 64 cm, 65 cm, 66 cm, 67 cm, 68 cm, 69 cm, 70 cm, 71 cm, 72 cm, 73 cm, 74 cm, or 75 cm in length.

In certain embodiments, provided herein is a composite having a separator and an LBHI, where the LBHI fills at least 90% of the through-pores and/or surface pores of the separator, and where the LBHI may be a composition having A·(LiBH₄)·B·(LiX)·C·(LiNH₂) wherein X is a halide wherein 3≤A≤6, 2≤B≤5, and 0≤C≤9.

In some embodiments, including any of the foregoing, the electrolyte separator is characterized by the empirical formula LiₓLa_{A}Zr_{B}Oₕ+yAl₂O₃, wherein 3≤x≤8, 2<A<4, 1<B<3, 0≤y≤1, and 6≤h≤15; and wherein subscripts x and h, and coefficient y are selected so that the electrolyte separator is charge neutral.

In some embodiments, including any of the foregoing, the electrolyte separator is doped with Ga, Nb, or Ta.

In some embodiments, including any of the foregoing, the electrolyte separator has a surface roughness, on at least one surface, from about 0.01 μm to 10 μm. In some embodiments, including any of the foregoing, the electrolyte separator has a surface roughness, on at least one surface, from about 0.01 μm to 5 μm. In some embodiments, including any of the foregoing, the electrolyte separator has a surface roughness, on at least one surface, from about 0.01 μm to 2 μm. In some embodiments, including any of the foregoing, the electrolyte separator has a density greater than 95% of its theoretical density. In some embodiments, including any of the foregoing, the electrolyte separator has a density greater than 95% of its theoretical density as determined by scanning electron microscopy (SEM). In some embodiments, including any of the foregoing, the electrolyte separator has a density greater than 95% of its theoretical density as measured by the Archimedes method. In some embodiments, including any of the foregoing, the electrolyte separator has a surface flatness of 0.1 μm to about 50 μm.

In some embodiments, including any of the foregoing, the lithium intercalation material is selected from the group consisting of a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, LiMn₂₋ₐNiₐO₄, wherein a is from 0 to 2, or LiMPO₄, wherein M is Fe, Ni, Co, and Mn.

In some embodiments, including any of the foregoing, the lithium conversion material is selected from the group consisting of FeF₂, NiF₂, FeOₓF₃₋₂ₓ, FeF₃, MnF₃, CoF₃, CuF₂ materials, alloys thereof, and combinations thereof.

In some embodiments, including any of the foregoing, the bonding layer penetrates into the positive electrode.

In some embodiments, set forth herein is an electrochemical stack, wherein the electrolyte separator has a thickness between about 10 nm and 50 μm; the bonding layer has a thickness between about 1 μm and 20 μm; and the positive electrode, exclusive of the current collector, has a thickness between about 5 μm and 150 μm.

In some embodiments, set forth herein is an electrochemical stack, wherein the electrolyte separator has a thickness between about 10 nm and 50 μm; the bonding layer has a thickness between about 1 μm and 20 μm; and the positive electrode, exclusive of the current collector, has a thickness between about 100 μm and 200 μm.

In some embodiments, the electrolyte separator has a surface roughness Ra or Rt, on at least one surface, from about 0.1 μm to 10 μm. In other examples, the electrolyte separator has a surface roughness, on at least one surface, from about 0.1 μm to 5 μm. In other examples, the electrolyte separator has a surface roughness, on at least one surface, from about 0.1 μm to 2 μm. In some embodiments, the electrolyte has a surface roughness from about 0.1 μm to 10 μm at the surface that interfaces the electrolyte separator and the Li metal negative electrode.

In some embodiments, the electrolyte separator has a density greater than 95% of its theoretical density. In other examples, the electrolyte separator has a density greater than 95% of its theoretical density as determined by scanning electron microscopy (SEM). In certain examples, the electrolyte separator has a density greater than 95% of its theoretical density as measured by the Archimedes method. In some embodiments, the electrolyte separator has a surface flatness of 0.1 μm to about 50 μm. In some embodiments, the lithium salt in the bonding layer is selected from LiPF₆, LiBOB, LiTFSi, LiBF₄, LiClO₄, LiASF₆, LiFSI, LiI, or LiBF₄. In certain examples, the lithium salt in the bonding layer is selected from LiPF₆, LiBOB, or LFTSi. In certain examples, the lithium salt in the bonding layer is LiPF₆ at a concentration of 0.5 M to 2M. In certain examples, the lithium salt in the bonding layer is LiTFSI at a concentration of 0.5 M to 2M. In certain examples, the lithium salt in the bonding layer is present at a concentration from 0.01 M to 10 M.

In some embodiments, the positive electrode includes a lithium intercalation material, a lithium conversion material, or both a lithium intercalation material and a lithium conversion material. In some embodiments, the lithium intercalation material is selected from a nickel manganese cobalt oxide Li(NiCoMn)O₂, (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), LiMn₂O₄, LiCoO₂, LiMn₂₋ₐNiₐO₄, wherein a is from 0 to 2, or LiMPO₄, wherein M is Fe, Ni, Co, or Mn. In others, the lithium conversion material is selected from the group consisting of FeF₂, NiF₂, FeOₓF₃₋₂ₓ, FeF₃, MnF₃, CoF₃, CuF₂ materials, alloys thereof, and combinations thereof. In others, the conversion material is doped with other transition metal fluorides or oxides.

In some embodiments, the positive electrode comprises LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; or LiNiₓCo_{y}Al_{z}O₂, wherein x+y+z=1, and 0≤x≤1, 0≤y≤1, and 0≤z≤1.

In some embodiments, the positive electrode comprises a manganese oxide (MnO), iron oxides, copper oxides, nickel oxides, lithium-manganese complex oxides (e.g., LiₓMn₂O₄ or LiₓMnO₂), lithium-nickel complex oxides (e.g., LiₓNiO₂), lithium-cobalt complex oxides (e.g. LiₓCoO₂), lithium cobalt nickel oxides (LiNi_{1-y}Co_{y}O₂), lithium-manganese-cobalt complex oxides (e.g., LiMn_{y}Co_{1-y}O₂), spinel-phase lithium-manganese-nickel complex oxides (e.g., LiₓMm_{2-y}Ni_{y}O₄), lithium phosphates having an olivine structure (e.g., LiₓFePO₄, LiₓFe_{1-y}Mn_{y}PO₄, LiₓCoPO₄), lithium phosphates having a NASICON-type structure (e.g., Li₇V₂(PO₄)₃), iron (III) sulfate (Fe₂(SO₄)₃), or vanadium oxides (e.g., V₂O₅). In some embodiments, x and y in these chemical formulas lie within the ranges of 1<x<5, and 0<y<1. In some embodiments, the positive electrode comprises LiCoO₂, LiₓV₂(PO₄)₃, LiNiPO₄, or LiFePO₄. In some embodiments, the positive electrode comprises La-doped LiCoO₂ or Al-doped LiCoO₂.

In some embodiments, including any of the foregoing, the positive electrode comprises LiNiₓMn_{y}Co_{z}O₂, x+y+z=1, 0.8≤x≤1, 0≤y≤1, and 0≤z≤1 and wherein x+y+z=1.

In some embodiments, including any of the foregoing, the positive electrode comprises LiNiₓMn_{y}Co_{z}O₂ and either (a)-(e):
(f) x is 0.8, y is 0.1, and z is 0.1;
(g) 0.8≤x≤0.97, 0≤y≤0.2, and 0≤z≤0.2;
(h) 0.8≤x≤0.90, 0≤y≤0.2, and 0≤z≤0.2;
(i) 0.8≤x≤0.85, 0≤y≤0.2, and 0≤z≤0.2; or
(j) 0.8≤x≤0.83, 0≤y≤0.2, and 0≤z≤0.2.

In the above formulas, the sum of x, y, and z is 1.

In some embodiments, the positive electrode includes an electronically conductive source of carbon.

In some embodiments, the positive electrode includes a solid catholyte and a lithium intercalation material or a lithium conversion material; wherein each of the catholyte and lithium intercalation material or a lithium conversion material independently has a d₅₀ particle size from about 0.1 μm to 5 μm. In some embodiments, the positive electrode includes a solid catholyte and a lithium intercalation material or a lithium conversion material; wherein each of the catholyte and lithium intercalation material or a lithium conversion material independently has a d₅₀ particle size from about 0.1 μm to 15 μm. In some embodiments, the bonding layer is characterized by a thickness of about 1 nm to about 5 μm. In some embodiments, the Li negative electrode is characterized by a thickness of about 10 nm to about 50 μm. In some embodiments, the oxide separator is characterized by a thickness of about 0.1 μm to about 150 μm. In some embodiments, oxide separator is characterized by a thickness of about 10 μm to about 50 μm.

In some embodiments, the coated edges include a coating selected from parylene, epoxy, polypropylene, polyethylene, alumina, Al₂O₃, ZrO₂, TiO₂, SiO₂, a binary oxide, a lithium carbonate species, La₂Zr₂O₇, or a glass, wherein the glass is selected from SiO₂—B₂O₃, or Al₂O₃. In some embodiments, the electrolyte separator has tapered edges which protect the bonding layer from creeping around the electrolyte separator. In some embodiments, the edges of the separator electrolyte have been selectively treated with heat (e.g. laser beam) or chemicals (e.g. plasma, water, acid, etc).

In some embodiments, set forth herein is an electrochemical stack having an electrolyte separator which has a thickness between about 10 and 20 μm; a bonding layer which has a thickness between about 1 μm and 5 μm; and a positive electrode, exclusive of the current collector, which has a thickness between about 5 μm and 150 μm. In some embodiments, set forth herein is an electrochemical stack having an electrolyte separator which has a thickness between about 10 and 50 μm; a bonding layer which has a thickness between about 1 μm and 5 μm; and a positive electrode, exclusive of the current collector, which has a thickness between about 5 μm and 200 μm. In some embodiments, set forth herein is an electrochemical stack having an electrolyte separator which has a thickness between about 10 and 100 μm; a bonding layer which has a thickness between about 1 μm and 5 μm; and a positive electrode, exclusive of the current collector, which has a thickness between about 5 μm and 200 μm. In some embodiments, set forth herein is an electrochemical stack having an electrolyte separator which has a thickness between about 1 μm and 50 μm; a bonding layer which has a thickness between about 1 μm and 5 μm; and a positive electrode, exclusive of the current collector, which has a thickness between about 100 μm and 200 μm. In some embodiments, set forth herein is an electrochemical stack having an electrolyte separator which has a thickness between about 1 μm and 50 μm; a bonding layer which has a thickness between about 1 μm and 5 μm; a buffer layer which has a thickness between about 5 μm and 15 μm; and a positive electrode, exclusive of the current collector, which has a thickness between about 100 μm and 200 μm.

In some embodiments, the electrochemical stack further includes a solid-state cathode frame such as, for example, any of the ones described in International Application No. PCT/US2025/025457, filed on Apr. 18, 2025, and titled CATHODE FRAMES FOR USE IN SOLID-STATE BATTERIES, the entire contents of which are incorporated herein by reference.

### Methods

In an aspect, set forth herein is a method of forming an electrochemical cell, the method including providing a solvent-free mixture comprising a cathode active material, a catholyte, and a binder; dough-kneading the mixture; depositing the kneaded mixture onto a surface; forming a free standing sheet of the deposited mixture; providing a solid-state buffer deposited on a substrate; disposing the free standing sheet on the solid-state buffer to form a stack; applying pressure and heat to the stack; depositing a bonding layer onto a separator; combining the stack with the separator having a bonding layer thereupon to form an electrochemical cell stack; and applying pressure and heat to the cell stack.

In an aspect, set forth herein is a method of forming an electrochemical cell, the method including providing a solvent-free mixture comprising a cathode active material, a catholyte, and a binder; dough-kneading the mixture; depositing the kneaded mixture onto a surface; forming a free standing sheet of the deposited mixture; providing a solid-state buffer deposited on a substrate; disposing the free standing sheet on the solid-state buffer to form a stack; applying pressure and heat to the stack; depositing a bonding layer onto the stack to form an assembly, where the bonding layer contacts the buffer layer; combining assembly with a separator to form an electrochemical cell stack, wherein the separator contacts the bonding layer; and applying pressure and heat to the cell stack.

In some embodiments, the pressure applied to the cell stack is about 70 kPa to about 1000 kPa, about 70 kPa to about 900 kPa, about 70 kPa to about 700 kPa, about 100 kPa to about 1000 kPa, about 100 kPa to about 900 kPa, about 130 kPa to about 900 kPa, about 130 kPa to about 620 kPa, about 130 kPa to about 550 kPa, about 200 kPa to about 550 kPa, about 200 kPa to about 480 kPa, about 270 kPa to about 480 kPa, or about 270 kPa to about 420 kPa.

In some embodiments, the temperature applies to the cell stack is about 80° C. to about 160° C., about 90° C. to about 160° C., about 100° C. to about 160° C., about 110° C. to about 160° C., about 120° C. to about 160° C., about 130° C. to about 160° C., or about 140° C. to about 160° C. In some embodiments, the temperature applies to the cell stack is about 80° C., about 90° C., about 100° C., about 110° C., about 120° C., about 130° C., about 140° C., about 150° C., or about 160° C.

In some embodiments, the temperature and/or pressure is applied to the cell stack for about 20 minutes, about 15 minutes, about 10 minutes, about 5 minutes, about 4 minutes, about 3 minutes, about 2 minutes, about 1 minute, or about 30 seconds. In some embodiments, the temperature and/or pressure is applied to the cell stack for less than about 20 minutes, less than about 15 minutes, less than about 10 minutes, less than about 5 minutes, less than about 4 minutes, less than about 3 minutes, less than about 2 minutes, or less than about 1 minute. In some embodiments, the temperature and/or pressure is applied to the cell stack for about 30 seconds to about 5 minutes, about 1 minute to about 5 minutes, about 5 minutes to about 20 minutes, about 10 minutes to about 20 minutes, or about 15 minutes to about 20 minutes.

Set forth herein are methods for making a solid-state cathode sheet, in which the process includes providing, or having provided, a solvent-free mixture comprising cathode active material particles, a catholyte, and binder particles; dough-kneading the mixture to form binder fibrils; and depositing the mixture to form a positive electrode sheet. In an example, the binder particles are present at 5% w/w or less. In an example, the binder particles are present at 1% w/w or less.

In some embodiments, the method of preparing a solid-state cathode sheet comprises mixing a mixture of cathode active material, a catholyte, and a binder and dough-kneading without solvent. In some embodiments, the method of preparing a solid-state cathode sheet comprises mixing while maintaining a mixture of cathode active material, a catholyte, and a binder and dough-kneading without solvent. In some embodiments, the method of preparing a solid-state cathode can include combining a cathode active material (e.g. NMC), a catholyte, and a binder (e.g., PTFE) and dough-kneaded in a mixer without solvent. A rubber kneader, rotary mortar, and/or extruder can be used to produce the dough mixture. The dough mixture can be sheeted or extruded into the target mass loading by using rollers to form the positive electrode layer. A buffer layer can then be applied to the sheet and calendered. The positive electrode layer with the applied buffer layer can proceed into a cutting system to form a strip. For example, the cutting system can be a mechanical cutting system such as a blanker, rotary cutter, share cutter, and/or DIE. Lastly, a laser is applied to form the solid-state cathode.

In some embodiments, including any of the foregoing, the process includes using a roller to press the cathode and cause PTFE fibrils to form and network in the cathode. In some embodiments, including any of the foregoing, the process includes using an extruder to shear the cathode mixture and cause PTFE fibrils to form and network in the cathode. In some embodiments, the process includes applying a calender press at final stage of the process to densify the cathode.

In some embodiments, including any of the foregoing, the dough-kneading the mixture comprises using a mortar.

In some embodiments, including any of the foregoing, the dough-kneading the mixture comprises using an extruder. Commercial examples of such extruders include, but are not limited to, a Process 11 by Thermo Fisher; or the 20 MM Twin Screw Mixing Line by Buhler. Other manufactures include Coperion.

In some embodiments, including any of the foregoing, the process further includes preprocessing the binder. For example, preprocessing may include, but is not limited to, atomization of the PTFE powder. One way to atomize the PTFE powder is blade mixing at cold temperature. In some embodiments, the cold temperature is below a phase transition temperature. In certain examples, the cold temperature is 10° C. to 20° C. In some embodiments, the cold temperature is below a phase transition temperature. In some embodiments, the cold temperature is at a phase transition temperature.

In some embodiments, the mixing of the mixture occurs at temperature below a phase transition temperature. In some embodiments, the phase transition temperature is from the triclinic phase of PTFE to the hexagonal phase of PTFE. In some embodiments, the mixing of the mixture occurs at a temperature below the onset of the phase transition temperature from the triclinic phase of PTFE to the hexagonal phase of PTFE.

In some embodiments, the mixing of the mixture occurs at a temperature of less than about 30° C., less than about 29° C., less than about 28° C., less than about 27° C., less than about 26° C., less than about 25° C., less than about 24° C., less than about 23° C., less than about 22° C., less than about 21° C., less than about 20° C., less than about 19° C., less than about 18° C., less than about 17° C., less than about 16° C., or less than about 15° C.

In some embodiments, the mixing of the mixture occurs at a temperature of about −30° C. to about 30° C., about −30° C. to about 23° C., about −30° C. to about 20° C., about −30° C. to about 19° C., or about −30° C. to about 15° C.

In some embodiments, the mixing of the mixture occurs at a temperature of about 5° C. to about 30° C., about 10° C. to about 30° C., about 5° C. to about 23° C., about 10° C. to about 23° C., about 5° C. to about 20° C., about 10° C. to about 20° C., about 5° C. to about 19° C., about 10° C. to about 19° C., about 5° C. to about 15° C., or about 10° C. to about 15° C.

In some embodiments, including any of the foregoing, the dough-kneading occurs at a temperature of about 18° C. to about 180° C. In some embodiments, including any of the foregoing, the dough-kneading occurs at a temperature of about 25° C. to about 200° C. In some embodiments, the dough-kneading occurs at a temperature of about 25° C. to about 150° C. In some embodiments, the dough-kneading occurs at a temperature of about 25° C. to about 100° C. In some embodiments, the dough-kneading occurs at a temperature of about 25° C. to about 75° C. In some embodiments, the dough-kneading occurs at a temperature of about 30° C. to about 75° C. In some embodiments, the dough-kneading occurs at a temperature of about 20° C. to about 60° C. In some embodiments, the dough-kneading occurs at a temperature of about 30° C. to about 60° C. In some embodiments, the dough-kneading occurs at a temperature of about 40° C. to about 60° C. In some embodiments, the dough-kneading occurs at a temperature of about 40° C. to about 50° C. In some embodiments, the dough-kneading occurs at a temperature of about 50° C. to about 80° C. In some embodiments, the dough-kneading occurs at a temperature of about 60° C. to about 80° C. In some embodiments, the dough-kneading occurs at a temperature of about 70° C. to about 80° C. In some embodiments, the dough-kneading occurs at a temperature of about 80° C. to about 100° C. In some embodiments, the dough-kneading occurs at a temperature of about 90° C. to about 100° C. In some embodiments, the dough-kneading occurs at a temperature of about 18° C.

A solid-state cathode sheet may be made by, for example, the methods in WO/2023/205462, which published Oct. 26, 2023, and was filed as International PCT Patent Application No. PCT/US2023/019468, filed Apr. 21, 2023, and entitled SOLVENT-LESS CATHODE COMPOSITION AND PROCESS FOR MAKING, the entire contents of which are herein incorporated by reference in their entirety for all purposes.

Lithium-stuffed garnet electrolyte separators are provided and plated into aluminum trays. A thin layer of bonding layer is deposited on the lithium-stuffed garnet electrolyte separator. Separately, positive electrodes are prepared having a binder, catholyte, and cathode active materials. Optionally, a buffer layer may be applied to the positive electrode. The positive electrode is then placed onto the bonding layer which is on the lithium-stuffed garnet electrolyte separator. The stack was laminated by applying heat.

The method can include applying pressure and heat to the stack; providing a solid-state separator; depositing a bonding layer onto the solid-state separator; combining the stack with the solid-state separator having a bonding layer thereupon to form an electrochemical cell stack; and applying pressure and heat to the cell stack.

In some embodiments, the buffer layer can be made by a calendering process, wherein the amount of force is at least about 100 psi, 500 psi, 1000 psi, 2000 psi, or more. In some embodiments, the buffer layer is made under elevated temperatures, such as great than about 40° C., 50° C., 75° C., 100° C., 120° C., 140° C., or more. In some embodiments, the buffer layer is heated to greater than about 100° C.

In certain embodiments, the temperature in the method is below the melting point (Tₘ) of the separator, and is about 0.8 Tₘ, where Tₘ is expressed in Kelvin (K). In certain embodiments, the method further includes c) holding the pressure between the composition and the separator for 1-300 min.

In certain embodiments, the method further includes d) cooling the coated lithium ion conducting separator electrolyte under pressure for 10-1000 min. In certain embodiments, the method further includes d) cooling the coated lithium ion conducting separator electrolyte under pressure for 10-1000 min to room temperature.

In some embodiments, including any of the foregoing, the bonding layer should be as thin as possible, for example, less than 10 μm, less than 5 μm, less than 2 μm, or less than 1 μm. The bonding layer may be a thin film which is deposited from solution via spray coating, gravure coating, slot die coating, dip coating, spin casting and similar techniques It may also be deposited from a melt above 50° C. A free standing thin film can also be pressed against the cathode and separator at elevated temperatures (>50° C.) and pressures (>100 psi).

In some embodiments, the pressure used during formation of a bonding layer, a buffer layer, a positive electrode layer, or any combination thereof, is at least 5000 Pascals, 10 kiloPascals (kPa), 100 kPa, 500 kPa, 1000 kPa, 10,000 kPa, 100,000 kPa, 1 MPa, 10 MPa, 100 MPa, or more. In some embodiments, the pressure used during formation of a bonding layer, a buffer layer, a positive electrode layer, or any combination thereof, is at least 1000 kPa, 10,000 kPa, 100,000 kPa, 1 MPa, 10 MPa, 100 MPa, or more.

In some embodiments, the pressure used during cycling of an electrochemical cell described herein is performed at atmospheric pressure.

In some embodiments, the pressure used during cycling of an electrochemical cell described herein is performed at more than atmospheric pressure and at a pressure of at least 100 Pascals, 1000 Pascals, 5000 Pascals, 10 kiloPascals (kPa), 100 kPa, 500 kPa, 1000 kPa, 10,000 kPa, 100,000 kPa, 1 MPa, 10 MPa, 100 MPa, or more. In some embodiments, the pressure used during cycling of an electrochemical cell described herein is performed at a pressure of about 5 kPa, about 10 kPa, about 25 kPa, about 50 kPa, about 75 kPa, about 100 kPa, about 125 kPa, about 150 kPa, about 175 kPa, about 200 kPa, about 225 kPa, about 250 kPa, about 275 kPa, about 300 kPa, about 325 kPa, about 350 kPa, about 375 kPa, or about 400 kPa.

In some embodiments, including any of the foregoing, the pressure is less than 1000 PSI (6895 kPa). In some embodiments, including any of the foregoing, the pressure is less than 300 PSI (2068 kPa). In some embodiments, including any of the foregoing, the temperature is less than 180° C. In some embodiments, including any of the foregoing, the temperature is less than 120° C. In some embodiments, including any of the foregoing, the process is performed in a clean room. In some embodiments, including any of the foregoing, the clean room has a Dewpoint less than −20° C., or less than −40° C. In some embodiments, including any of the foregoing, the clean room is a class 10,000 cleanroom.

### EXAMPLES

Reagents, chemicals, and materials were commercially purchased unless specified otherwise to the contrary. Pouch cell containers were purchased from Showa Denko. The Electrochemical potentiostat used was an Arbin potentiostat and Maccor potentiostat. Electrochemical impedance spectroscopy (EIS) was performed with a Biologic VMP3, VSP, VSP-300, SP-150, or SP-200. Mixing was performed using a Fischer Scientific vortex mixer, a Flaktek speed mixer, or a Primix filmix homogenizer. Casting was performed on a TQC drawdown table. Calendering was performed on an IMC calender. Electron microscopy was performed in a FEI Quanta SEM, a Helios 600i, or a Helios 660 FIB-SEM, though equivalent tools may be substituted. DC cycling was performed with Arbin BT-2043, or BT-G, though it is understood that equivalent tools may be substituted.

Unless specified otherwise, lithium-stuffed garnet films were prepared as follows. A slurry of lithium-stuffed garnet precursor materials were deposited by the doctor-blade method on aluminum-based setters and sintered at 1000° C. to 1300° C. to prepare thin-films of lithium-stuffed garnet that were about 50 microns (μm) in thickness.

Unless specified otherwise, co-sintered films (CSC films) were prepared as follows. A slurry of lithium-stuffed garnet precursor materials were casted onto mylar. A second slurry comprising nickel particles and additional lithium-stuffed garnet precursor materials was deposited (either method of screen-printed or casting) on top of the slurry of lithium-stuffed garnet materials. The resulting CSC film was sintered on aluminum-based setters at 1000° C. to 1300° C. to prepare CSC films that were about 50 microns in thickness.

Unless specified otherwise, bilayer (film on metal foil) were prepared as follows. A slurry of lithium-stuffed garnet precursor materials was cast onto a metal foil and dried to form a green tape. The bilayer was sintered at 1000° C. to 1300° C. The sintered films were then cut to the appropriate dimensions using a laser cutter. It is contemplated that a blade blanking tool could also be used. The bilayer films herein are prepared, for example, as in WO/2023/154571, published Aug. 17, 2023, as in WO/2022/192464, published Sep. 15, 2022, or as in WO/2024/059730, published Mar. 21, 2024, wherein the entire contents of all three references are incorporated herein by reference.

The Lithium Nickel Cobalt Manganese Oxide (NMC) used in the Examples was LiNi_{0.8}Co_{0.1}Mn_{0.1}O₂ or LiNi_{0.83}Co_{0.09}Mn_{0.08}O₂unless specified otherwise.

### Example 1—Method 1: Solid-State Battery Assembly

Three solid-state batteries were assembled. Each included a lithium-stuffed garnet electrolyte separator which was 50 μm thick. A 50 μm thick positive electrode was prepared having a PVDF/PTFE binder and NMC active material. The positive electrode included an argyrodite solid-state catholyte. The volume ratio of NMC particles to argyrodite particles was approximately 80:20. However, the NMC active material loading was systematically varied to values of 20 mg/cm², 28 mg/cm², and 56 mg/cm². This was accomplished by making the positive electrode progressively thicker.

A 20 μm thick Li metal negative electrode was also included by charging the solid-state battery after it was assembled.

The solid-state batteries were electrochemically cycled between 3.0 and 4.25 Volts (V) versus Li, wherein Li is at 0V, at 30° C.

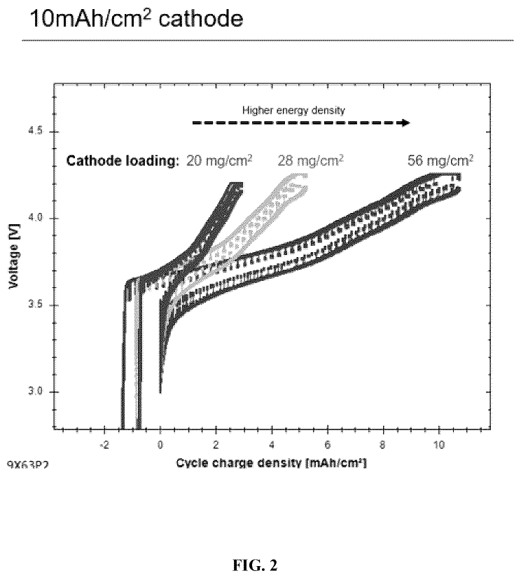

The plot of voltage as a function of cycle charge density in FIG. 2 shows an increase in energy density in association with an increase in active material loading in the positive electrode.

FIG. 2 is a plot of voltage as a function of cycle charge density for cathode loadings of 20 mg/cm², 28 mg/cm², and 56 mg/cm².

The solid-state batteries were charged and discharged at 1C rates, wherein the current density of 1C for each cell is the following: 3.7 mA/cm² for the 20 mg/cm², 5.5 mA/cm² for the 28 mg/cm², and 10 mA/cm² for the 56 mg/cm². The solid-state batteries were circular 11 mm diameter cells wherein the cathode and separator were 8 mm and 11 mm in diameter, respectively. The current density during discharge was 10 mA/cm². FIG. 2 demonstrates how energy density varies with increasing active material loading.

### Example 2—Performance at 80° C.: (4C/1C Cycling)

A solid-state battery as in Example 1 was made.

The solid-state batteries were charged at 4C rates and discharged at 1C rates. The solid-state batteries were circular 11 mm diameter cells wherein the cathode and separator were 8 mm and 11 mm in diameter, respectively. The current density during discharge was 5.5 mA/cm². The batteries were under 300 pounds per square inch of pressure at and 80° C. After 100 cycles, 95% of the normalized discharge energy was retained. This is associated with a 95% capacity retention after 100 cycles.

The performance at 80° C. at a 10C fast charging resulted in 55 mA/cm². Specifically, a 5-80% (6.4 mA/cm² at 80° C.), 5-90% (C/3 capacity check 5.5 mA/cm² at 30° C.), at 5 minutes and 18 seconds, was determined from plotting the charge density versus cycle time. Good performance at this cycling condition is an indication of the quality of the battery.

### Example 3—Storage of Batteries

A solid-state battery as in Example 1 was made.

The batteries were charged to 100% SOC and stored at room temperature under inert conditions. The batteries were stored at 4.25V under 60° C. for 4 weeks.

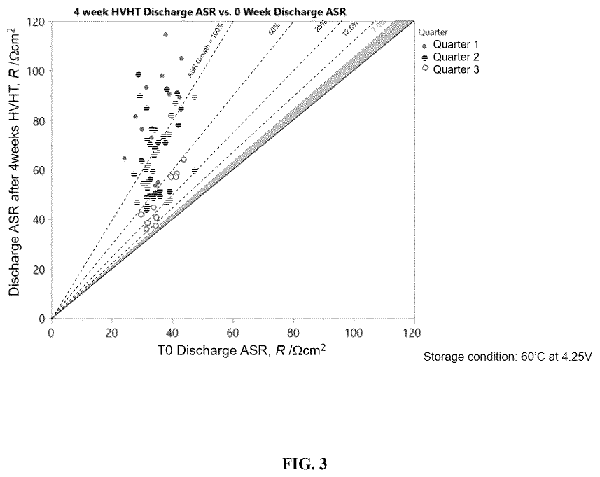

The four week storage results indicate impedance has significantly not changed. See FIG. 3 which plots ASR as a function of days stored.

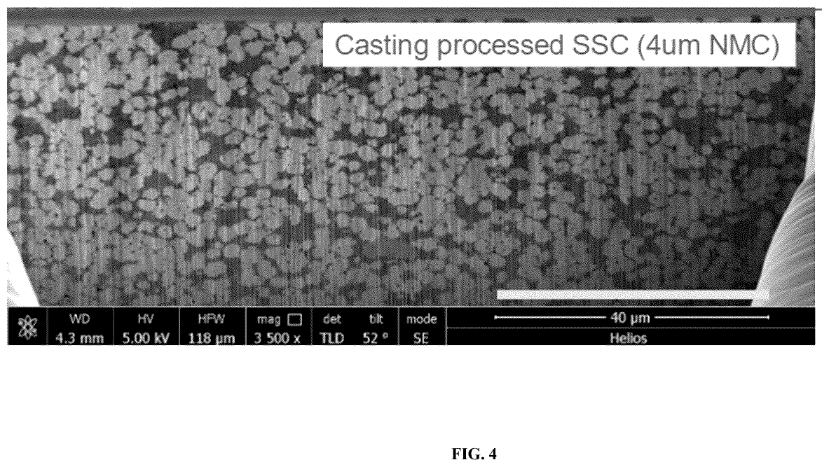

FIG. 4 illustrates a focused ion-beam cross-sectional SEM of an example solid-state cathode having 4 μm sized NMC active material particles prepared by solvent-casting process.

A solid-state battery as in Example 1 was prepared.

The batteries were charged to 100% SOC and stored at room temperature under inert conditions. The batteries were stored at 4.25V under 60° C. for 4 weeks. High voltage high temperature storage test (HVHT).

The four week storage results indicate impedance has significantly not changed. See FIG. 3 which plots ASR as a function of days stored. HVHT is an accelerated ageing test. Low ASR growth after an HVHT test is an indication of good battery quality.

### Example 4—SEM Measurement

FIG. 4 illustrates a focused ion-beam cross-sectional SEM of an example solid-state cathode having 4 μm sized NMC active material particles prepared by solvent-casting process.

To prepare the cathode layer by solvent-casting process, following procedure was applied.
Step 1: A DNA based binder was dissolved in Tripropylamine. The binder content is 9 wt %.
Step 2: The solution made by step 1 (3.67 g) was added to Tripropylamine (8.5 g) to adjust the concentration of binder.
Step 3: NMC (21.6 g) and catholyte (3.6 g) were put into the solution prepared by step 2 and then mixed in the solution to make a slurry of electrode.
Step 4: The slurry was casted using doctor blade and the solvent was dried at 75° C. for 2-4 hours.

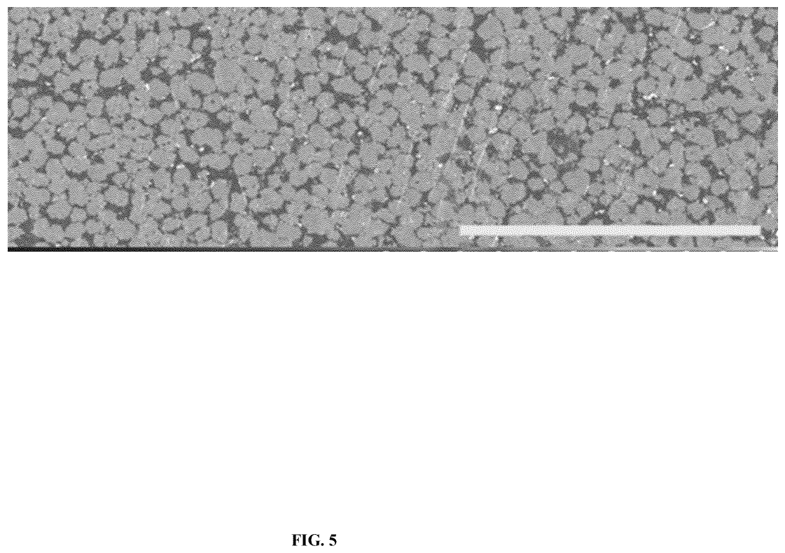

FIG. 5 illustrates a focused ion-beam cross-sectional SEM of an example solid-state cathode made using a dry (solvent-free) process.

The bar in FIGS. 4-5 is 50 μm.

### Example 5—EIS Measurement of Cathode Layer

Symmetrical cells were fabricated by charging the solid state cathode (positive electrode) to SOC 50% with slow charging. Symmetrical cell is a stack of positive electrode, separator, and positive electrode. The separator was prepared with sulfide electrolyte powder in the aluminum oxide cylinder by pressing the powder at 50 MPa using stainless steel pistons. After separator fabrication, the charged positive electrode was placed on both sides of the separator. Then the stack of positive electrode, separator, and positive electrode was pressed using 400 MPa of pressure. After pressing, the cell was fixtured with 100 MPa of pressure and the electric impedance spectroscopy was measured to obtain the impedance of the positive electrode.

The area-specific resistance (ASR) of cathode was measured by EIS using the symmetric cells fabricated by above procedure.

The area-specific resistance (ASR) associated with the example using the solvent-casting process was −20 Ωcm². The area-specific resistance (ASR) associated with the example using the dry process was −5 Ωcm².

### Example 6—Method 2: Solid-State Battery Assembly

Battery stacks were constructed using bilayer films (i.e., separators) comprising a lithium-stuffed garnet layer and a metal layer and the layers described below.

A first and second positive electrode (i.e., cathode) layer was prepared. A solvent-free cathode mixture was prepared by mixing 87 wt % of lithium-zirconium-oxide (LZO) coated NMC, 12 wt % LPSCl, and 1 wt % PTFE at a temperature of about 10° C. to about 20° C. The mixture was then extruded at a temperature of about 40° C. to about 60° C. to fibrillate the PTFE and subsequently sheeted to form a first solid-state cathode sheet. A second solid-state cathode sheet was prepared in the same manner as the first solid-state cathode sheet. Each solid-state cathode sheet was applied to opposite sides of a carbon coated Al foil to form a double-sided solid-state cathode.

A first and second sulfide buffer layer was prepared. A slurry was prepared with 10-70 wt % LSTPS in toluene. The LSTPS composition was characterized as LiₐSi_{b}Sn_{c}PdSₑ, wherein a is 5, b is 0.75, c is 0.25, d is 1, and e is 6, and further it comprised an oxygen element from greater than 0 to 15 atomic %, and was prepared as described in U.S. Pat. No. 9,172,114, which issued Oct. 27, 2015, and is titled SOLID STATE CATHOLYTES AND ELECTROLYTES FOR ENERGY STORAGE DEVICES, the entire contents of which are herein incorporated by reference in their entirety for all purposes. The slurry was cast using a doctor blade casting method on Ni foil. The resulting cast slurry was dried at room temperature to 120° C. for 1-24 hours to form a buffer layer film (i.e., first buffer layer). A second buffer layer was prepared using the same procedure as the first buffer layer. Without being bound to theory, it was proposed that this layer was not conductive to electrons (had an electron conductivity less than 1E-6 S/cm). The buffer layer films were peeled off (i.e., removed) from the Ni foil after the drying. The buffer layers were placed on top of the cathode layers so that the first buffer layer and the first cathode layer, and separately, the second buffer layer and the second cathode layer, are in direct contact with each other to produce a subassembly (buffer layer-positive electrode layer-aluminum foil).

The subassembly from above is placed on an aluminum guide foil. The subassembly is then passed through a calender at 1.0 meters/min, 140° C., and ˜100-110bar (10-11 MPa) hydraulic pressure (to apply 1100-1200 N/mm). Saueressig GK 300 L or Ono Roll Type 12 or Hitachi calenders were used. Once calendered, the subassembly layers were densified together in one step. Cathode electrodes of approximately 21 mm×21 mm or 65 mm×50 mm were cut from the subassembly sheet by means laser cutting or blanking and punching. The calendered thickness of each cathode layer was about 100 μm to about 200 μm, and the porosity was about 1% to about 10% by volume as determined by scanning electron microscopy.

A first anode seal was applied to the major surface of a first anode current collector foil with a tab, and a second anode seal was applied to the major surface of a second anode current collector foil with a tab. The first and second anode seal were respectively placed in contact with the anode side of a first and second bilayer film to form anode substacks, wherein the anode seal contacts the metal layer of the bilayer film.

A first and a second lithium borohydride bonding layer was prepared. The borohydride composition used to form the borohydride bonding layer was described according to WO2018075972A1, filed Oct. 20, 2017, and titled ELECTROLYTE SEPARATORS INCLUDING LITHIUM BOROHYDRIDE AND COMPOSITE ELECTROLYTE SEPARATORS OF LITHIUM-STUFFED GARNET AND LITHIUM BOROHYDRIDE; also WO2019078897A1, filed Oct. 20, 2017, and titled BOROHYDRIDE-SULFIDE INTERFACIAL LAYER IN ALL SOLID-STATE BATTERY, the entire contents of which are herein incorporated by reference in their entirety for all purposes. The first and second lithium borohydride bonding layer was separately deposited on top of the first and second substack, so that the first bonding layer contacted the lithium-stuffed garnet layer of the first bilayer film and the second bonding layer contacted the lithium-stuffed garnet layer of the second bilayer film.

The cathode electrode from above was assembled along with a first and second cathode frame to form frame-on-cathode assembly using the methods described in International Application No. PCT/US2025/025457, filed on Apr. 18, 2025, and titled CATHODE FRAMES FOR USE IN SOLID-STATE BATTERIES, the entire contents of which are incorporated herein by reference. An example of such methods is detailed below.

A PTFE liner was placed on a stainless-steel substrate to prevent static and attachment of any electrochemical stack components during assembly. Next, a first cathode frame was placed on the PTFE liner. The assembly from above was placed within the frame and centered with respect to the frame center and the first cathode, so that the first frame surrounds the perimeter of the first cathode layer. Next, a second frame identical to the first frame was placed and centered with respect to the frame center and the second cathode layer of the double-sided cathode. The inner frame length, inner frame width, and overall frame thickness were larger than the respective length, width, and thickness of either of the solid-state cathode layers of the double-sided solid-state cathode. A second PTFE liner followed by a second stainless steel substrate was placed on top of the assembly.

The assembly was heated at a temperature of about 65° C. to about 75° C. and at a pressure of about 70 kPa to about 700 kPa for 2 minutes. The frame-on-cathode assembly was taken out and allowed to cool to room temperature.

A PTFE liner was placed on top of a high temperature silicone foam to prevent static and attachment of any electrochemical stack components during assembly. A first anode substack with bonding layer from above was placed on the PTFE liner. Then the frame-on-cathode assembly from above was placed on first anode substack and centered with respect to the anode substack center. Next, a second anode substack identical to the first anode substack was placed and centered with respect to the frame-on-cathode assembly center. A second PTFE liner followed by a second high temperature silicone foam were placed on top of the assembly to provide uniform pressure distribution. Finally, the stack was heated at temperature about 80° C. to 160° C. and at a pressure of about 140 kPa to 830 kPa for several minutes. The cell stack was then cooled to room temperature.

A pouch was sealed around the cell, with the tabs sticking out of the cell to make electrical connections to each electrode.

### Example 7—Cell Performance: 1C/1C Cycling at 30° C.

Electrochemical cells were prepared as in Example 6 above. The NMC active material loading of the double-sided cathode was 30 mg/cm². The cell was charged from 3.0-4.25V at a constant current of 0.33C for 952 seconds, followed by a constant current charge at 1.33C until reaching the top-of-charge (TOC) voltage, after which a constant voltage (CV) phase was applied and maintained until the current tapered to a 0.2C cutoff. After 10 minutes of post charge rest, the cell was discharged at 1C. Such cell was then cycled 2000 times at 30° C.

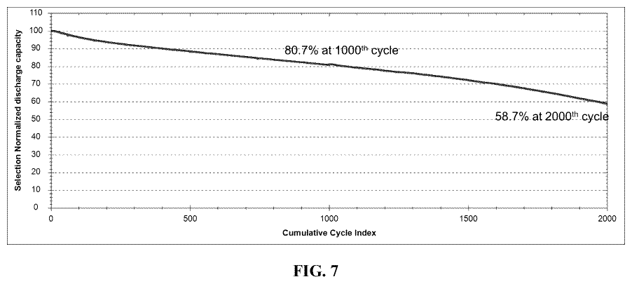

The results are shown in FIG. 7. The battery demonstrated an 80.7% capacity retention after 1000 cycles and a 58.7% capacity after 2000 cycles. This data demonstrates that the battery can undergo many cycles. Long term cycling is a challenging test for a battery.

### Example 8—Cell Performance: 4C/0.5C Cycling at 45° C.

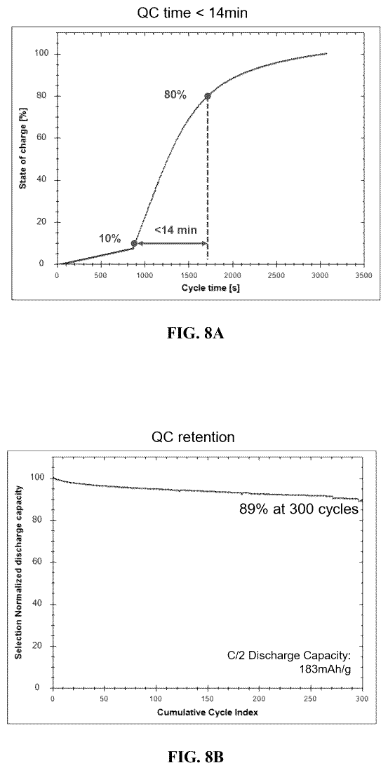

A solid-state battery was prepared as in Example 6 above. The NMC active material loading of the double-sided cathode was 30 mg/cm². The battery was cycled at 4C-0.5C at 45° C., where the battery was under 200 kPa of pressure. The cell was charged from 3.0-4.25V at a constant current of 0.33C for 865 seconds, followed by a constant current charge at 4C until reaching the top-of-charge (TOC) voltage, after which a constant voltage (CV) phase was applied and maintained until the current tapered to a 0.2C cutoff. After 10 minutes of post charge rest, the cell was discharged at 0.5C. Such cell was then cycled 300 times at 45° C. The results are shown in FIGS. 8A-8B.

FIG. 8A demonstrates the state of charge (SOC) vs. cycle time for the 4C/1C cycling detailed in Example 8. As seen from the SOC curve, the quick charge time (i.e, time it took for the battery SOC to increase from 10% to 80%) was less than 14 minutes.

FIG. 8B demonstrates the discharge capacity as a function of cycle number for the 4C/1C cycling detailed in Example 8. As shown FIG. 8B, the battery demonstrated an 89% capacity retention after 300 cycles. 4C/0.5C at 45C is a stress test for the battery and a challenging cycling condition. Good performance at this cycling condition is an indication of the quality of the battery.

### Example 9—Cell Performance: HVHT

Circular 11 mm diameter cells were prepared similar to Example 1. A 140 μm thick positive electrode was prepared having a PVDF/PTFE binder, NMC active material and LPSCl catholyte. The weight ratio of NMC active material to LPSCl was approximately 87:12. The NMC active material loading of the positive electrode was 30 mg/cm². The cells were assembled with a lithium-stuffed garnet electrolyte separator, which was 29 μm thick. The positive electrode and separator were 8 mm and 11 mm in diameter, respectively.

A 25 μm thick Li metal negative electrode was also included by charging the cells after they were assembled.

The cells were charged from 3.0-4.25V at a constant current of 0.33C until reaching the top-of-charge (TOC) voltage, after which a constant voltage (CV) phase was applied and maintained until the current tapered to a 0.05C cutoff at 30° C. The cell area-specific resistance (ASR) from the first C/3 cycle for 6 individual cells was measured.

Then the cells were stored in a 60° C. oven for 7 or 28 days. After HVHT storage, the cells was then discharged at 0.33C.

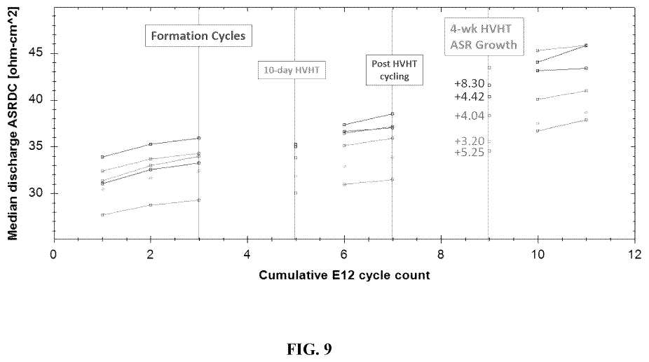

The results are shown in FIG. 9, for 6 individual cells. The 4-week ASR ranges between 10.5% and 27% relative to the initial ASR prior to storage at high voltage and high temperature.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. An electrochemical cell comprising:
a positive electrode current collector;
a positive electrode comprising a catholyte;
a solid-state buffer layer in contact with the positive electrode and opposite the positive electrode current collector;
a separator comprising a lithium-stuffed garnet layer and a metal layer;
wherein the thickness of the solid-state buffer layer is greater than 0% and less than 50% the thickness of the positive electrode.

2. An electrochemical cell comprising:
a positive electrode current collector;
a positive electrode comprising a catholyte;
a solid-state buffer layer in contact with the positive electrode and opposite the positive electrode current collector;
a separator comprising a lithium-stuffed garnet layer and a metal layer;
wherein the thickness of the solid-state buffer layer is 0.5 μm to 50 μm.

3. The electrochemical cell of claim 1 or 2, further comprising a bonding layer between the solid-state buffer layer and the separator.

4. The electrochemical cell of claim 3, wherein the bonding layer is between the solid-state buffer layer and the lithium-stuffed garnet layer of the separator.

5. The electrochemical cell of claim 3, wherein the bonding layer is disposed on the face of the solid-state buffer layer.

6. The electrochemical cell of any one of claims 1-5, further comprising a negative electrode current collector and lithium metal between the negative electrode current collector and the separator.

7. The electrochemical cell of any one of claims 1-6, wherein the catholyte and the solid-state buffer layer are made of the same material.

8. The electrochemical cell of claim 7, wherein the same material is LSTPS, LPSI, LPSCl, or LPSBr, argyrodite, Li_{7-z}PS_{6-z}X_{z}, wherein X is Cl, Br, I, or combinations thereof and 0≤z≤2.

9. The electrochemical cell of any one of claims 1-6, wherein the catholyte and the solid-state buffer layer are not made of the same material.

10. The electrochemical cell of any one of claims 1-9, wherein the positive electrode comprises cathode active material and at least one binder.

11. The electrochemical cell of any one of claims 1-9, wherein the lithium-stuffed garnet in the separator is characterized by the formula LiₓLa_{y}Zr_{z}Oₜ·qAl₂O₃, wherein 4<x<10, 1<y<4, 1<z<3, 6<t<14, and 0≤q≤1; or
LiₐLa_{b}Zr_{c}Al_{d}Me″ₑO_{f}, wherein 5<a<8.5; 2<b<4; 0≤c≤2.5; 0≤d<2; 0≤e<2, and 10<f<13 and Me″ is a metal selected from the group consisting of Nb, Ga, Ta, and combinations thereof.

12. The electrochemical cell of any one of claims 1-11, wherein the thickness of the lithium-stuffed garnet electrolyte separator is 10 μm to 100 μm.

13. The electrochemical cell of any one of claims 1-12, wherein the metal layer comprises a metal selected from the group consisting of nickel (Ni), iron (Fe), copper (Cu), aluminum (Al), tin (Sn), indium (In), platinum (Pt), gold (Au), silver (Ag), steel, an alloy thereof, and a combination thereof.

14. The electrochemical cell of claim 13, wherein the metal layer comprises nickel.

15. The electrochemical cell of claim 13, wherein the metal layer comprises iron.

16. The electrochemical cell of claim 13, wherein the metal layer comprises an alloy.

17. The electrochemical cell of claim 16, wherein the metal layer comprises an alloy of Fe and Ni, and the amount of Fe is about 1% to about 25% (w/w) with the remainder being Ni.

18. The electrochemical cell of claim 16, wherein the metal layer comprises an alloy of Al and Ni, and the amount of Al is about 1% to about 25% (w/w) with the remainder being Ni.

19. A solid-state battery comprising:
a positive electrode comprising cathode active material, at least one binder, and a catholyte;
a solid-state buffer layer disposed on the positive electrode;
a bonding layer disposed on the solid-state buffer layer; and
a separator disposed on the bonding layer,
wherein the separator comprises a lithium-stuffed garnet layer and a metal layer; and
wherein the solid-state buffer layer comprises the same material as the catholyte material.

20. The solid-state battery of claim 19, wherein
the lithium-stuffed garnet layer of the separator comprises a lithium-stuffed garnet selected from LiₓLa_{y}Zr_{z}Oₜ·qAl₂O₃, wherein 4<x<10, 1<y<4, 1<z<3, 6<t<14, and 0≤q≤1; or
wherein the lithium-stuffed garnet layer of the separator comprises a lithium-stuffed garnet characterized by the formula LiₐLa_{b}Zr_{c}Al_{d}Me″ₑO_{f}, wherein 5<a<8.5; 2<b<4; 0≤c≤2.5; 0≤d<2; 0≤e<2, and 10<f<13 and Me″ is a metal selected from the group consisting of Nb, Ga, Ta, and combinations thereof.

21. The solid-state battery of any one of claims 19-20, wherein the solid-state buffer layer has a uniform thickness from 5 μm to 15 μm.

22. The solid-state battery of any one of claims 19-20, wherein the solid-state buffer layer has a non-uniform thickness having an average thickness of 5 μm to 15 μm.

23. The solid-state battery of any one of claims 19-22, wherein the solid-state buffer layer prevents electron transfer across the solid-state buffer layer.

24. The solid-state battery of any one of claims 19-23, wherein the positive electrode layer does not include an electronically conductive additive.

25. The solid-state battery of claim 24, wherein the electronically conductive additive is a carbon-based electronically conductive additive.

26. The solid-state battery of claim 24 or 25, wherein the electronically conductive additive is C65, graphitic carbon, graphene, or a combination thereof.

27. The solid-state battery of any one of claims 19-26, wherein the cathode active material has a D₅₀ particle size of 1 μm to 8 μm.

28. The solid-state battery of any one of claims 19-27, wherein the cathode active material is selected from nickel manganese cobalt oxide (NMC), a nickel cobalt aluminum oxide (NCA), or combinations thereof.

29. The solid-state battery of any one of claims 19-28, wherein the cathode active material selected from lithium cobalt oxide (LCO), lithium nickel cobalt aluminum oxide (NCA), lithium nickel manganese cobalt oxide (NMC), lithium iron phosphate (LFP), and combinations thereof.

30. The solid-state battery of any one of claims 19-29, wherein the cathode active material includes a core of a nickel manganese cobalt oxide (NMC), a nickel cobalt aluminum oxide (NCA), or combinations thereof, wherein the core is coated with a coating selected from lithium-lanthanum-zirconium oxide (LLZO), lithium niobium oxide, lithium zirconium oxide, lithium aluminum oxide, lithium phosphate, lithium tantalum oxide, lithium hafnium oxide, niobium oxide, zirconium oxide, aluminum oxide, tantalum oxide, hafnium oxide, or combinations thereof.

31. The solid-state battery of any one of claims 19-30, wherein the catholyte material includes LiₓPₓS_{y}Cl_{z}, wherein 0<w<13, 0<x<3, 0<y<12, and 0<z<10.

32. The solid-state battery of any one of claims 19-30, wherein the catholyte material includes Li_{w}PₓS_{y}X_{z}, wherein 0<w<13, 0<x<3, 0<y<12, and 0<z<10, and wherein X is Cl, Br, or I.

33. The solid-state battery of any one of claims 19-22, wherein the catholyte material includes Li_{w}MₓM′_{y}P_{z}Sᵥ, wherein 0<w<20, 0≤x≤1, 0≤y≤1, 0<z<4, 0<v<12, and wherein M and M′ are independently Si, Ge, or Sn.

34. The solid-state battery of any one of claims 19-22, wherein the binder is PVDF, PTFE, or combinations thereof.

35. The solid-state battery of any one of claims 19-22, wherein the bonding layer comprises a composition comprising:
$$A \cdot ( {LiBH}_{4} ) \cdot B \cdot ( Li X ) \cdot C \cdot ( {LiNH}_{2} ) ,$$
wherein X is fluorine, bromine, chlorine, iodine, or a combination thereof, and
wherein 1≤A≤6, 2≤B≤5, and 0≤C≤9.

36. The solid-state battery of claim 35, wherein
A=3, B=1, C=2;
A=3, B=2, C=3;
A=3, B=3, C=4;
A=1, B=1, C=3; or
A=3.3, B=1.4, C=5.3.

37. The solid-state battery of any one of claims 19-36, wherein the bonding layer comprises a gel composition comprising a lithium salt and a solvent.

38. The solid-state battery of any one of claim 37, wherein the lithium salt is LiSFI, LiTSFI, LiPF₆, or combinations thereof; wherein the solvent is 1,3-dioxolane, dimethoxyethane, or combinations thereof.

39. The solid-state battery of any one of claims 19-38, further comprising a negative electrode.

40. The solid-state battery of 39, wherein the negative electrode is a lithium (Li) metal negative electrode.
